(19) United States
(12) Patent Application Publication
(10) Pub. No.: US 2017/0110094 A1
(43) Pub. Date: Apr. 20, 2017

(54) METHOD AND APPARATUS FOR TRANSMITTING AND RECEIVING INFORMATION BY ELECTRONIC DEVICE

(71) Applicant: Samsung Electronics Co., Ltd, Gyeonggi-do (KR)

(72) Inventors: Sangwook Kwon, Gyeonggi-do (KR); Kyungkyu Kim, Gyeonggi-do (KR); Youngjoong Mok, Gyeonggi-do (KR); Youngbin Chang, Gyeonggi-do (KR); Jonghyung Kwun, Seoul (KR)

(21) Appl. No.: 15/295,945

(22) Filed: Oct. 17, 2016

(30) Foreign Application Priority Data
Oct. 16, 2015 (KR) 10-2015-0144673

(51) Int. Cl. G09G 5/32; G06T 17/05; G06F 3/14; H04W 4/00; G06F 3/01

(52) U.S. Cl. CPC G09G 5/32; H04W 4/005; G06F 3/013; G06F 3/1454; G06T 17/05

(57) ABSTRACT

An electronic apparatus for transmitting and receiving information includes a transceiver configured to transmit and receive data, and a controller configured to cause the transceiver to receive display related information from at least one display, select at least one of the at least one display, and receive data from the selected at least one display based on the at least one display related information. An electronic apparatus for transmitting and receiving data includes a transceiver, and a controller configured to cause the transceiver to detect an image of a screen displayed on a display, determine whether a region including code information exists on a screen, decrypt the code information in the region, and receive data based on the decrypted code information.

### CROSS-REFERENCE TO RELATED APPLICATION AND CLAIM OF PRIORITY

The present application is related to and claims priority from and the benefit under 35 U.S.C. §119(a) of Korean Patent Application No. 10-2015-0144673, filed on Oct. 16, 2015, which is hereby incorporated by reference for all purposes as if fully set forth herein.

### TECHNICAL FIELD

Various embodiment of the present disclosure relate to a method and an apparatus for receiving information by an electronic device, and more particularly, a method and an apparatus for transmitting and receiving information to and from at least one display.

BACKGROUND

To meet a demand for radio data traffic that is on an increasing trend since commercialization of a 4G communication system, efforts to develop an improved 5G communication system or a pre-5G communication system have been conducted. For this reason, the 5G communication system or the pre-5G communication system is called a communication system beyond 4G network or a system since the post LTE. To achieve a high data transmission rate, the 5G communication system is considered to be implemented in a super high frequency (mmWave) band (for example, like 60 GHz band). To relive a path loss of a radio wave and increase a transfer distance of a radio wave in the super high frequency band, in the 5G communication system, beamforming, massive MIMO, full dimensional MIMO (FD-MIMO), array antenna, analog beam-forming, large scale antenna technologies have been discussed. Further, to improve a network of the system, in the 5G communication system, technologies such as advanced small cell, cloud radio access network cloud (RAN), ultra-dense network, device to device communication D2D, wireless backhaul, moving network, cooperation communication, coordinated multi-points (CoMP), and interference cancellation has been developed. In addition to this, in the 5G system, hybrid FSK and QAM modulation (FQAM) and sliding window superposition coding (SWSC) which are an advanced coding modulation (ACM) scheme and a filter bank multi carrier (FBMC), a non-orthogonal multiple access (NOMA), and a sparse code multiple access (SCMA) which are an advanced access technology, or the like have been developed.

Meanwhile, the Internet is evolved to an Internet of Things (IoT) network that transmits and receives information, such as things, between distributed components and processes the information, in a human-centered connection network through which human generates and consumes information. The Internet of Everything (IoE) technology in which a big data processing technology, or the like by a connection with a cloud server, or the like is combined with the IoT technology has also emerged. To implement the IoT, technology elements, such as a sensing technology, wired and wireless communication and network infrastructure, a service interface technology, and a security technology, have been required. Recently, technologies such as a sensor network, machine to machine (M2M), and machine type communication (MTC) for connecting between things has been researched. In the IoT environment, an intelligent Internet technology (IT) service that creates a new value in human life by collecting and analyzing data generated in the connected things may be provided. The IoT may be applied to fields, such as a smart home, a smart building, a smart city, a smart car or a connected car, a smart grid, a health care, smart appliances, and an advanced healthcare service by fusing and combining the existing information technology (IT) with various industries.

Therefore, various tries to apply the 5G communication system to the IoT network have been conducted. For example, the 5G communication technologies such as the technologies of the sensor network, the machine to machine (M2M), the machine type communication (MTC) are implemented by techniques such as the beam-forming, the MIMO, the array antenna, or the like. As the big data processing technology described above, the application of the cloud radio access network (cloud RAN) may also be an example of the fusing of the 5G technology with the IoT technology.

Meanwhile, an outdoor display does not transmit additional information other than a screen output. With the development of mobile communication technologies, a user may recognize information through a screen displayed on the display and may receive and reproduce additional information associated with the screen that is displayed on the display by using a user terminal. when a plurality of displays are near users, a method for selecting a display for receiving additional information is required.

### SUMMARY

In some embodiments, an electronic apparatus for transmitting and receiving information includes a transceiver configured to transmit and receive data, and a controller configured to cause the transceiver to receive display related information from at least one display, select at least one of the at least one display, and receive data from the selected at least one display based on the at least one display related information.

In some embodiments, an electronic apparatus for transmitting and receiving data includes a transceiver, and a controller configured to cause the transceiver to detect an image of a screen displayed on a display, determine whether a region including code information exists on a screen, decrypt the code information in the region, and receive data based on the decrypted code information.

In some embodiments, a method for transmitting and receiving information by an electronic device includes receiving display related information from at least one display, receiving a command for selecting at least one of the at least one display, and receiving data from the selected at least one display based on the at least one display related information.

In some embodiments, a method for displaying information on a display and transmitting and receiving the information includes confirming the display related information, displaying the confirmed display related information on a portion of a screen using code information, and transmitting data to the electronic device in response to receiving a data request message based on the code information from an electronic device.

In some embodiments, a display for displaying information and transmitting and receiving the information includes transceiver, a display, a controller configured to confirm a display related information, display the confirmed display related information in a portion of a screen using code information, and transmit data to an electronic device in response to receiving a data request message based on the code information from an electronic device, wherein the controller is further configured to cause the display to display a predetermined pattern using a color value code of a screen pixel as a starting point of a code region, and cause the display to display code information in some of the plurality of image frames when the screen displays on the display includes the plurality of image frames.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example selection of a display using directional data by an electronic device according to an embodiment of the present disclosure.

FIGS. 2A and 2B illustrate an example selection of the display using geomagnetism related information by the electronic device according to an embodiment of the present disclosure.

FIGS. 3A and 3B illustrate an example method for determining geomagnetism related information for selecting a display according to an embodiment of the present disclosure.

FIGS. 4A to 4D illustrate an example method for determining geomagnetism related information for selecting a display according to an embodiment of the present disclosure.

FIG. 5 illustrates an example selection of a display using beamforming by the electronic device according to an embodiment of the present disclosure.

FIG. 6 illustrates an example display of a screen based on geographic information on a display by an electronic device and selection of a display by receiving an input from a user according to another embodiment of the present disclosure.

FIGS. 7A and 7B illustrate an example display of a screen based on geographic information on a display by an electronic device and selection of a display by receiving an input from a user according to another embodiment of the present disclosure.

FIGS. 8A and 8B illustrate an example method for receiving map information from a separate map server by an electronic device to display a screen based on map information on a display according to another embodiment of the present disclosure.

FIGS. 9A and 9B illustrate an example method for receiving map information including information on a display from a server by an electronic device to display a screen based on map information on the display according to another embodiment of the present disclosure.

FIG. 10 illustrates an example method for displaying a screen based on map information on a display using zone information on the display by an electronic device according to another embodiment of the present disclosure.

FIGS. 11A and 11B illustrate an example method for displaying a screen based on map information on a display using an access point (AP) that is indoors by an electronic device according to another embodiment of the present disclosure.

FIGS. 12A and 12B illustrate an example method for determining and display priority between a plurality of displays by an electronic device according to another embodiment of the present disclosure.

FIGS. 13A and 13B illustrate an example method for acquiring distance calculation information for determining priority between a plurality of displays according to another embodiment of the present disclosure.

FIGS. 14A and 14B illustrate an example method for acquiring line of sight determination information for determining priority between a plurality of displays according to another embodiment of the present disclosure.

FIG. 15 illustrate an example method for determining whether a display is present in a progress direction of an electronic device for determining priority between a plurality of displays by the electronic device according to another embodiment of the present disclosure.

FIGS. 16A and 16B illustrate an example method for preventing listening again, in selecting a display by an electronic device according to another embodiment of the present disclosure.

FIGS. 17A and 17B illustrate an example method for selecting a display in consideration of preference of a user by an electronic device according to another embodiment of the present disclosure.

FIG. 18 illustrates an example method for receiving information by recognizing a screen of a display by an electronic device according to another embodiment of the present disclosure.

FIG. 19 illustrates an example method for receiving information by recognizing a predetermined pattern displayed on a screen of a display by an electronic device according to another embodiment of the present disclosure.

FIGS. 20A and 20B illustrate an example method for receiving information by recognizing an inserted code by changing a pixel in a portion of an area of a screen of a display by an electronic device according to another embodiment of the present disclosure.

FIGS. 21A and 21B illustrate an example method for receiving information by recognizing an inserted code by changing a pixel in a portion of an area of a screen of a display by an electronic device according to another embodiment of the present disclosure.

FIG. 22 illustrates an example method for controlling data received from a display based on sensing of an operation of a user by an electronic device according to another embodiment of the present disclosure.

FIG. 23 illustrates an example internal structure of a display according to various embodiments of the present disclosure.

FIG. 24 illustrates an example internal structure of an electronic device according to various embodiments of the present disclosure.

### DETAILED DESCRIPTION

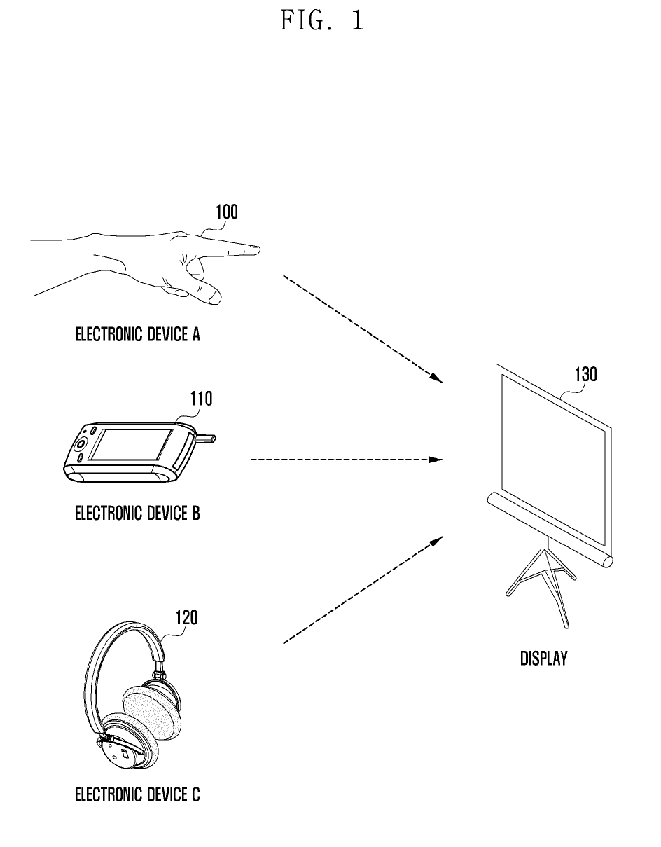

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

Hereinafter, exemplary embodiments of the present disclosure will be described in detail with reference to the accompanying drawings.

In describing the exemplary embodiments of the present disclosure in the present specification, a description of technical contents which are well known to the art to which the present disclosure belongs and are not directly connected with the present disclosure will be described. This is to more clearly transfer a gist of the present specification by omitting an unnecessary description.

For the same reason, some components are exaggerated, omitted, or schematically illustrated in the accompanying drawings. Further, the size of each component does not exactly reflect its real size. In each drawing, the same or corresponding components are denoted by the same reference numerals.

Various advantages and features of the present disclosure and methods accomplishing thereof will become apparent from the following description of embodiments with reference to the accompanying drawings. However, the present disclosure is not be limited to the embodiments set forth herein but may be implemented in many different forms. The present embodiments may be provided so that the disclosure of the present disclosure will be complete, and will fully convey the scope of the disclosure to those skilled in the art and therefore the present disclosure will be defined within the scope of claims. Like reference numerals throughout the specification denote like elements.

In this case, it may be understood that each block of processing flow charts and combinations of the flow charts may be performed by computer program instructions. Since these computer program instructions may be installed in processors of a general computer, a special computer, or other programmable data processing apparatuses, these computer program instructions executed through the process of the computer or the other programmable data processing apparatuses create means performing functions described in block(s) of the flow chart. Since these computer program instructions may also be stored in a computer usable memory or a computer readable memory or other programmable data processing apparatuses that may direct a computer or other programmable data processing apparatuses in order to implement functions in a specific scheme, the computer program instructions stored in the computer usable memory or the computer readable memory may also produce manufacturing articles including instruction means performing the functions described in the block(s) of the flow chart. Since the computer program instructions may also be installed in a computer or other programmable data processing apparatuses, they perform a series of operation steps on the computer or the other programmable data processing apparatuses to create processes executed by the computer, such that the computer program instructions executing the computer or the other programmable data processing apparatuses may also provide steps for performing the functions described in the block(s) of the flow chart.

In addition, each block may indicate some of modules, segments, or codes including one or more executable instructions for executing a specified logical function(s). Further, it is to be noted that functions mentioned in the blocks may be performed regardless of a sequence in some alternative embodiments. For example, two blocks that are shown in succession may be simultaneously performed in fact or may be sometimes performed in a reverse sequence depending on corresponding functions.

Here, the term ‘-unit’ used in the present embodiment means software or hardware components such as FPGA and ASIC and the ‘unit’ performs any roles. However, the meaning of the ‘unit’ is not limited to software or hardware. The ‘unit’ may be configured to be in a storage medium that may be addressed and may also be configured to reproduce one or more processor. Therefore, as an example, ‘unit’ includes components such as software components, object oriented software components, class components, and task components, processes, functions, attributes, procedures, subroutines, segments of a program code, drivers, firmware, a microcode, a circuit, data, database, data structures, tables, arrays, and variables. The functions provided in the components and the ‘units’ may be combined with a smaller number of components and the ‘units’ or may further separated into additional components and ‘units’. In addition, the components and the ‘units’ may also be implemented to reproduce one or more CPUs within a device or a security multimedia card.

According to the present disclosure, an electronic device may be a device including a communication function. For example, the electronic device may be one of various devices such as a smart phone, a tablet personal computer (PC), a mobile phone, a video telephone, an e-book reader, a desktop personal computer (PC), a laptop personal computer (PC), a netbook computer, a personal digital assistant (PDA), a portable multimedia player, an MP3 player, mobile medical instrument, an electronic bracelet, an electronic necklace, an electronic accessory, a camera, a wearable device, an electronic clock, and a wrist watch or at least one combination thereof. It is apparent to those skilled in the art that the electronic device according to the present disclosure is not limited to the foregoing devices.

In the present disclosure, the display may be one of home appliances (for example, refrigerator, air conditioner, cleaner, oven, microwave oven, washing machine, air cleaner), an artificial intelligence robot, TV, a digital video disk (DVD) player, audio, various medical instruments (for example, magnetic resonance angiography (MRA), magnetic resonance imaging (MRI), computed tomography (CT), movie camera, ultrasonic instrument, or the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, a car infotainment device, electronic equipment for ship (for example, navigation device for ship, gyro compass, or the like), avionics, security equipment, a head-mounted display (HMD), a flat panel display, an electronic frame, an electronic album, a portion of building/structure, an electronic board, an electronic signature receiving device, and a display that may display a screen like a projector or at least one combination thereof. Hereinafter, for convenience an outdoor display installed in buildings, or the like will be described as an example but it is apparent to those skilled in the art that the display according to the present disclosure is not limited thereto.

Further, the display may include a transmitter or may be connected to or separated from the transmitter. The transmitter may transmit information associated with an image that is displayed on the display or transmit information independent thereof. The transmitter may include communication modules (LTE, LTE-D2D, Wi-Fi, Bluetooth, or the like). The communication module may support predetermined short-range communicationcan protocols (for example, wireless fidelity (WiFi), Bluetooth (BT), near field communication (NFC)) or predetermined network communications (for example, Internet, local area network (LAN), wire area network (WAN), telecommunication networks (for example, worldwide interoperability for microwave access (WIMAX), long-term evolution (LTE), LTE-device to device (D2D), or the like), a cellular network, a satellite network, or plain old telephone service (POTS), or the like.

In the present disclosure, display related information is called information required to allow an electronic device to identify and select a display. According to various embodiments of the present disclosure, the display related information may include channel information displayed on a display, positional information of the display, identification (ID) of the display, index information on the display, distance calculation information, LOS determination information, or the like.

The present disclosure relates to a method for selecting a portion of a plurality of displays by an electronic device and receiving data associated with the display. Hereinafter, embodiments to which the present disclosure may be applied will be described. For convenience, embodiments will be described based on operation types of the electronic device and the display but one of the following embodiments or a combination thereof may be practiced and it is apparent to those skilled in the art that the present disclosure is not limited thereto.

Type 1—type of allowing an electronic device to receive at least one display related information and select the display based on the received information to receive data.

Type 2—type of allowing an electronic device to receive and recognize a screen displayed on a display using an image recognition technology and receive data from the corresponding display.

First, embodiments included in the type 1 will be described with reference to FIGS. 1 to 17.

FIG. 1 is a diagram illustrating selection of a transmitter using directional data by an electronic device and reception of information, according to an embodiment of the present disclosure.

In more detail, the electronic device may include at least one of electronic devices 100, 110, and 120 that have directivity and may transmit directional data. The directional data which are data including directivity may include, for example, beamforming, geomagnetism information, or the like.

According to the embodiment of the present disclosure, the electronic device A 100 is a ring type wearable device. In more detail, the electronic device A 100 may include at least communication module (for example, antenna that may perform beamforming, or the like) that may transmit directional data for a direction that a front face of the electronic device A 100 indicates when the ring type wearable device puts on a finger. For example, the front face of the electronic device A 100 is indicated in a direction in which a display 130 is present, and thus a pointing electronic device A 100 may transmit directional data of the electronic device A 100 to the display 130. When receiving a response to the directional data from the display 130, the electronic device A 100 may select the display 130 to receive information. Alternatively, when receiving the response to the directional data from the display 130, the electronic device A 100 may adjust upward priority of the display 130.

Further, it is apparent to those skilled in the art that the method for applying to the electronic device A 100 according to the present disclosure may be changed to be applied even to a terminal like an electronic device B 110, a headphone like an electronic device C 120, or the like. Hereinafter, the detailed embodiment that uses geomagnetism related information and beamforming in the method for transmitting directional data described with reference to FIG. 1 will be described.

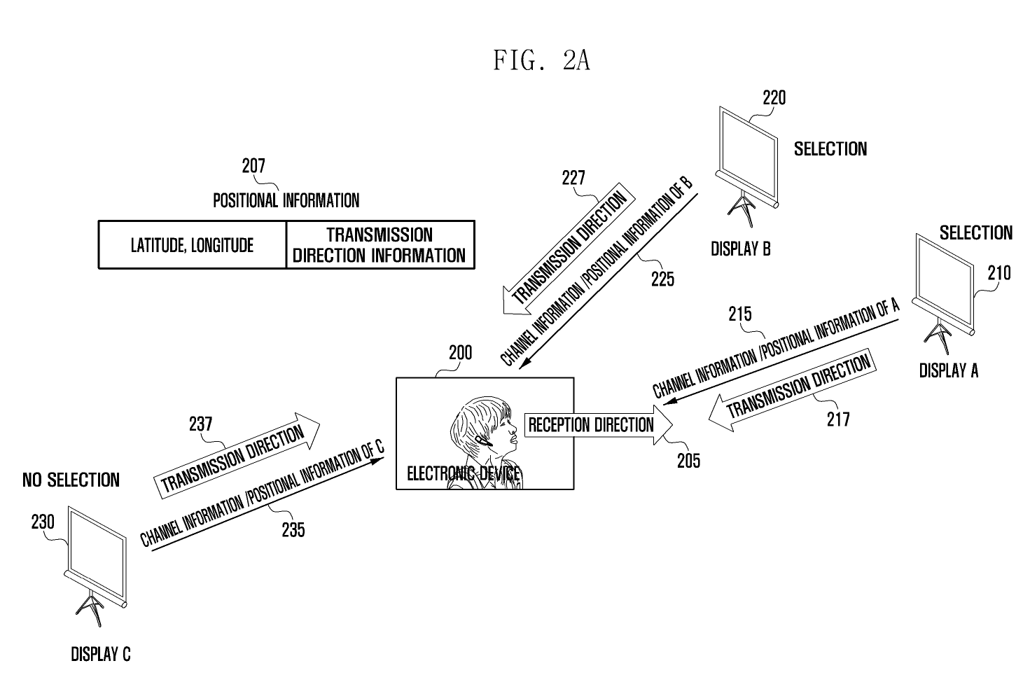

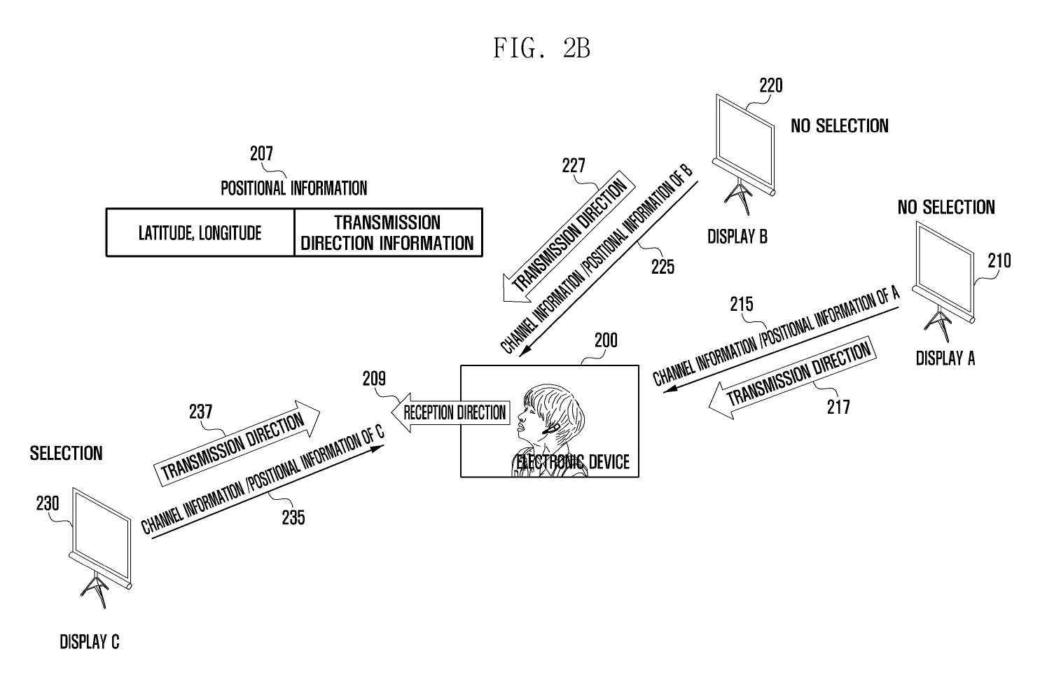

FIGS. 2A and 2B are diagrams illustrating selection of the display using geomagnetism related information by the electronic device according to an embodiment of the present disclosure.

In more detail, FIGS. 2A and 2B are diagrams illustrating a detailed embodiment depending on a direction in which the electronic device indicates.

First, the embodiment of the present disclosure will be described under the assumption that a display A 210, a display B 220, and a display C 230 are present around an electronic device 200. Actual transmission directions of screens from each display are represented by a grey arrow direction (217, 227, 237). The electronic device 200 may receive channel information and positional information from three displays (215, 225, 235). The positional information 207 may include at least one of latitude, longitude, and transmission direction information.

The electronic device 200 may also identify its own positional information (latitude, longitude, or reception direction) and transmit the identified positional information to the displays. The displays 210, 200, and 230 and the electronic device 200 may include apparatuses (for example, compass, gyro sensor, or the like) that may figure out directions of each apparatus to determine the positional information.

The electronic device 200 may use the positional information of the displays 210, 220, and 230 and its own positional information to determine the display that may be shown to a user among the current displays 210, 220, and 230 around the electronic device 200. For example, the case in which a difference between a transmission direction of the display and a reception direction of the electronic device is equal to or less than a predetermined value is selected. The transmission direction and the reception direction may be represented by a predetermined angle value.

That is, FIG. 2A illustrates that the electronic device selects the display A and the display B when the difference between the reception direction of the electronic device 200 and the transmission direction of the display A 210 and the display B 220 is equal to or less than a predetermined value. FIG. 2B illustrates that when the direction of the electronic device 200 is changed in an opposite direction, only the display C 230 is matched with the reception direction of the electronic device 200, and thus the electronic device 200 may select the display C 230.

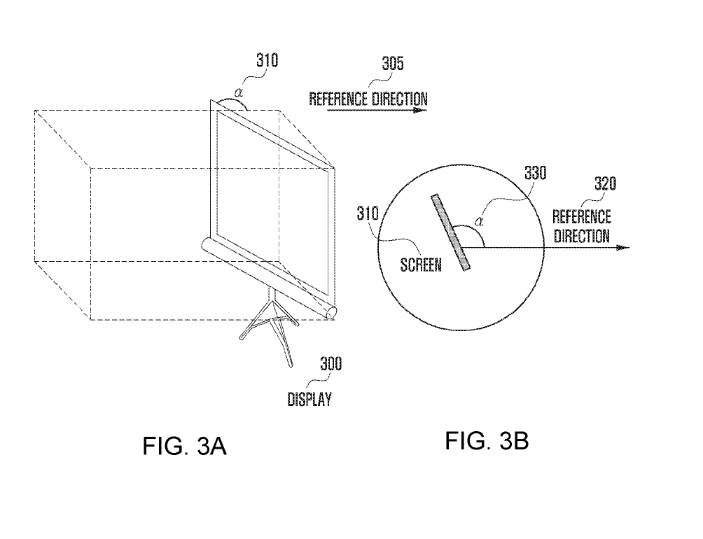

FIGS. 3A and 3B are diagrams illustrating a method for determining geomagnetism related information for selecting a display according to an embodiment of the present disclosure.

In more detail, FIG. 3A illustrates that the transmission direction among the positional information transmitted from the displays is determined as a predetermined angle value. It is assumed that a display 300 is installed like FIG. 3A. To determine the transmission direction, a reference direction 305 may be first determined. According to the embodiment of the present disclosure, the reference direction 305 is determined as a due north direction. According to the embodiment of the present disclosure, the transmission direction may be determined as a difference angle a 310 between a right direction that is a straight line with respect to the display based on a front face of a screen of the display 300 and a reference direction. The difference angle may be determined as a smaller angle in consideration of a clockwise direction and a counterclockwise direction. FIG. 3B illustrates that a display 310 illustrated in a plan view of FIG. 3A is viewed from the top, in which the transmission direction may be determined as a difference value a 330 between a right direction that is a straight line with respect to a front face 310 of a screen of the display 310 and a reference direction 320.

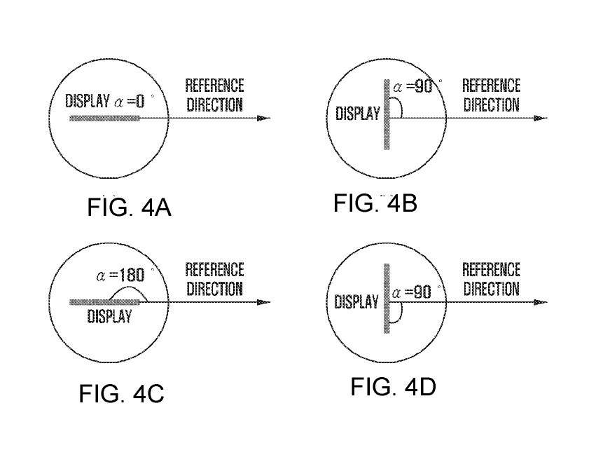

FIGS. 4A to 4D are diagrams illustrating a method for determining geomagnetism related information for selecting a display according to an embodiment of the present disclosure.

In more detail, FIGS. 4A to 4D each illustrate various examples of one plan view described in FIG. 3B. FIG. 4A illustrates that the transmission direction α is0° since a right direction that is a straight line with respect to the front face 310 of the screen matches a reference direction and FIG. 4B illustrates that 90° that is a difference value between a right direction that is a straight line with respect to the display based on the front face of the screen of the display 300 and the reference direction is determined as the transmission direction α. Further, FIG. 4C illustrates that 180° that is a difference value between a right direction that is a straight line with respect to the display based on the front face of the screen and the reference direction is determined as the transmission direction α. Further, FIG. 4D illustrates that 90° that is the difference value between the right direction that is a straight line with respect to the display based on the front face of the screen and the reference direction is determined as the transmission direction α.

However, in the examples of FIGS. 3 and 4, the angle formed by the right direction that is the straight line with respect to the display based on the front face of the screen and the reference direction is determined as the transmission direction, but an angle formed by a left direction that is a straight line with respect to the display based on the front face of the display or a front direction that is vertical to the display and a reference direction may be determined as the transmission direction. The transmission direction indicates the direction in which the display is installed and is not limited by the method described in the present disclosure.

Further, the electronic device may also determine the reception direction by the same direction as a method for calculating a transmission direction that the display performs. Based on this, the electronic device determines the display satisfying a predetermined condition based on the angle at which the direction in the display and the direction in the electronic device face each other. For example, when a sum of the difference value between the right direction that is a straight line with respect to the electronic device based on the front face of the electronic device and the reference direction and the difference value between the right direction that is a straight line with respect to the electronic device based on the front face of the display and the reference direction is 180□, it may be determined that the display and the electronic device face each other. When the difference is within a predetermined range based on this, it may be determined that the user of the electronic device is positioned in the direction that may see the display.

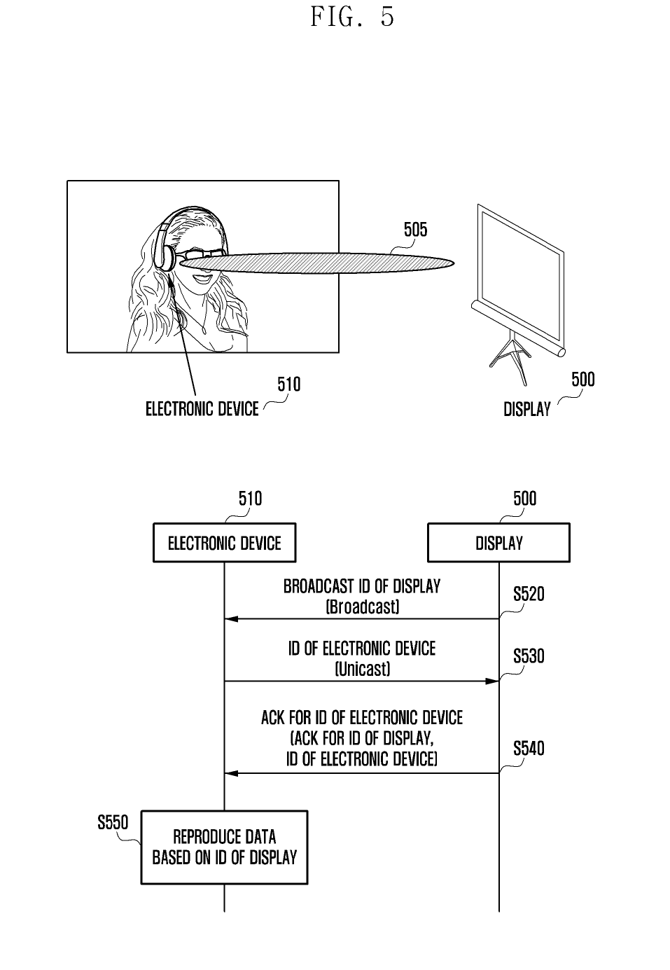

FIG. 5 is a diagram illustrating selection of a display using beamforming by the electronic device according to an embodiment of the present disclosure.

A display 500 according to the present disclosure may include an antenna that may receive a beamforming data 505 and an electronic device 510 may include an antenna that may transmit the beamforming data 505. The display 500 may broadcast identification (ID) information on the display in omnidirection (S520). Further, the display 500 may broadcast the information corresponding to a display ID to electronic devices that are present in omnidirection. The information corresponding to ID of the display may include data associated with a screen displayed on the display 500. Alternatively, the information associated with the screen displayed on the display 500 may include an URL address that may receive the data associated with the screen, or the like.

After receiving ID of the display, the electronic device 510 illustrated in FIG. 5 may broadcast ID of the electronic device through the beamforming antenna (S530). If the direction defined by a predetermined reference of the electronic device 510 directs to the display, the display 500 may receive the ID of the electronic device through the beamforming antenna of the electronic device 510.

When receiving the ID of the electronic device, the display 500 may broadcast ACK for the ID of the electronic device (ACK for the ID of the display and the ID of the electronic device) to the receiving device (S540). When receiving the ACK for the ID of the electronic device broadcast from the display 500, the electronic device 510 may use the information corresponding to the ID of the display 500 and the ID of the display 500 that are received prior to transmitting the ID of the electronic device 510 to reproduce data corresponding to the ID of the display 500. First, when the information corresponding to the ID of the display 500 is data that may be reproduced, the electronic device 510 may directly receive and reproduce the information. Alternatively, as another example of the present disclosure, the information corresponding to the ID of the display 500 is the URL address that may be connected to a specific contents provider server, the electronic device may access the server to receive the corresponding the information.

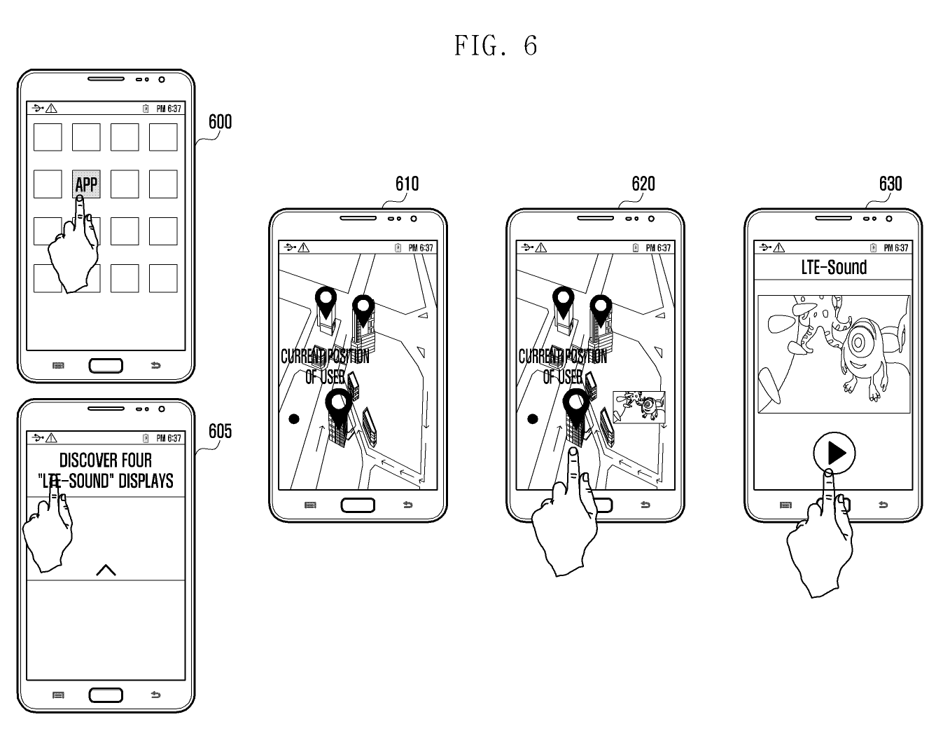

FIGS. 6 to 11B are diagrams for describing a method for using, by an electronic device, geographic information to display a display, when at least one display is present around the electronic device in the case in which the electronic device includes a display that displays a user interface (UI), according to the present disclosure.

FIG. 6 is a diagram illustrating display of a screen based on geographic information on a display by an electronic device and selection of a display by receiving an input from a user according to another embodiment of the present disclosure.

In more detail, FIG. 6 is a diagram illustrating the electronic device using the geographic information on the display to display the information on the display on the screen, when at least one display is present around the electronic device in the case in which the electronic device includes a display that displays the user interface (UI).

First, when at least one display around the electronic device is sensed, the information on the display may be displayed. In this case, there may be a method 600 for displaying when a user performs triggering by the method for displaying information on a display and a method 605 for displaying when an input of a user is present after alert using an upper alert window. There is a method for executing the corresponding application under a triggering condition of a user or using a uniform resource locator (URL) link using an address window on a web. The required information may be displayed on the alert window, including the sensed number of displays that performs operations proposed in the present disclosure.

When the triggering of the user is sensed or the input of the user is sensed after alert using the upper alert window, the electronic device may display the position of the electronic device and the position of the display on a map through a specific application screen, or the like (610). In this case, a method for representing the displayed icon and a pattern of the displayed icon may be difference according to each embodiment. If necessary, a map may be aligned by a compass based on a magnetic direction, that is, an orientation in which a user stands and then illustrated. In addition, the map may be realigned every time a movement/rotation, or the like of a user is sensed. Further, the pattern of the map may be illustrated in a 3D map or a street view in which an actual picture of city is modeled. In this case, the 3D map may be illustrated as a spherical or a semi-spherical map. Different embodiments will be described below in detail.

The electronic device may sense an input of a user that touches one of icons of a display that are illustrated on the map (620). The electronic device may receive information depending on contents corresponding to the touched icons of the display in response to the input (630). For example, when the display broadcasts speech information proposed in the present disclosure, a play button may be enabled and according to another embodiment, if there is added information (for example, thumbnail of an image, or the like), the added information may be provided.

The speech information may be automatically reproduced when display icons displayed on a map are touched or may be reproduced when separate buttons (for example, play button) are touched, according to the embodiment. On the other hand, when the electronic device receives information other than speech broadcast from the display, instead of the play button, a means that may represent information may be displayed. For example, when the electronic device receives performance information, a performance poster, the performance poster may be displayed on the screen and information about performance reservation through a poster may be continuously displayed.

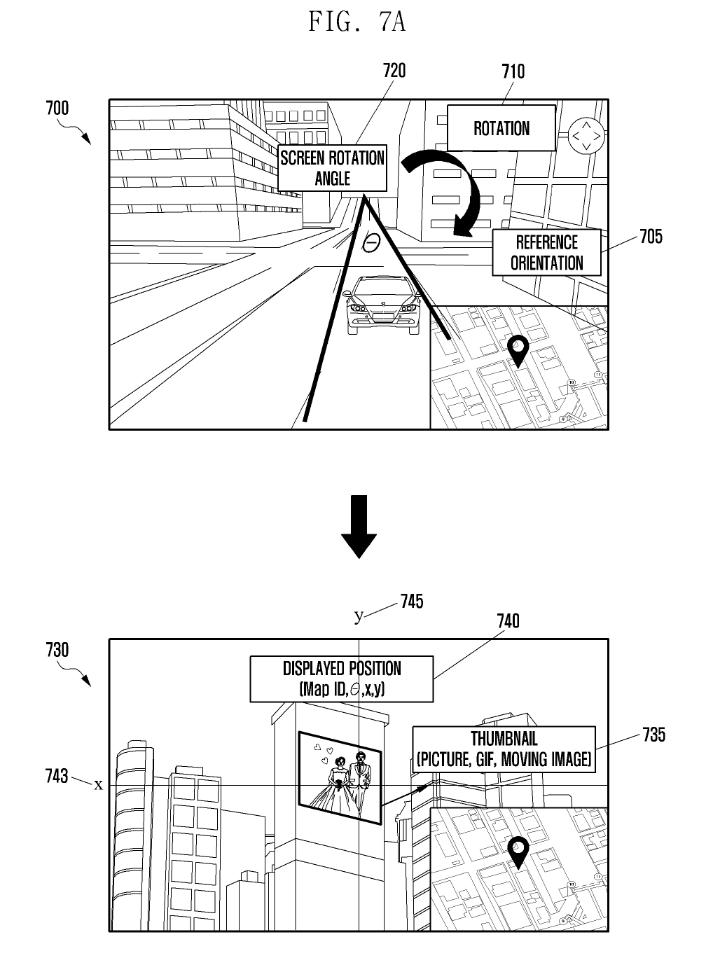

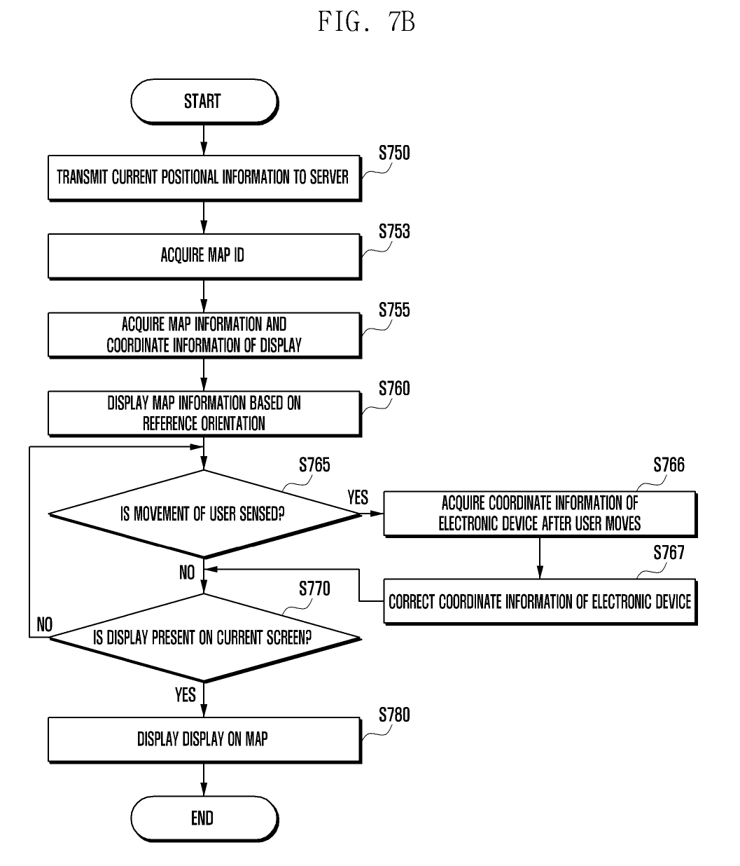

FIGS. 7A and 7B are diagrams illustrating display of a screen based on geographic information on a display by an electronic device and selection of a display by receiving an input from a user according to another embodiment of the present disclosure.

In more detail, FIG. 7A is a diagram illustrating the electronic device using the geographic information on the display to display the display on the screen in a street view modeling an actual picture of city, when at least one display is present around the electronic device in the case in which the electronic device includes a display that displays the UI.

As the first example, the method for performing, by a user, a street view in the electronic device first displays a map base on the positional information of the user and performs a specific button or a command to be switched to the street view. As another example, the street view may be immediately performed based on the positional information of the user without a separate command. Another example, there is a method for recognizing, by a user, a separately input position to display the corresponding area on a map and then performing a specific button or a command to be switched to the street view or immediately display the street view of the corresponding area.

If the street view is performed in the electronic device, the method proposed in the present disclosure may display a picture based on a specific reference. The reference may be changed according to the embodiment. As one example, an orientation may be used. If the screen is displayed based on a north, a scene seen in a picture may be compared with reality and the screen may be dragged to move to the 3D to thereby be displayed. Further, when the actual display is present at a place where the display is positioned in a picture, a thumbnail (e.g. GIF, moving image, picture) associated with the screen displayed on the display, a specific icon, or the like may be displayed at the place. The user may select the displayed display through a touch screen of the display of the electronic device to reproduce or download content.

According to one embodiment of the technical implementation described in FIG. 7A, the server may transmit a picture of 360° at the position of the electronic device or the designated position, ID of a picture, coordinate information at a picture if the display is present within 360° to the electronic device. Reference numeral 700 displays, for example, a picture of 360° received by the electronic device. In this case, in the picture, for example, a reference orientation (north) 705 is displayed based on a specific reference. If it is assumed that the specific reference is an orientation (north), the storage may store information on a virtual line, for example, an X axis or a Y axis that is present on a straight line of a picture based on the reference orientation. In this case, if the display mapped to the picture ID is not present, additional operation is never present.

Next, the user may input operations such as a drag to the electronic device through the touch screen. For example, the electronic device may sense that the user moves the screen and rotates (710) the screen. The electronic device may identify a screen rotation angle 720 rotated from an axis based on the reference orientation 705. Next, the electronic device may store the rotated angle as a theta (0) value. If the rotation is designated as up, down, left, and right sides, the theta value may be separated into two values of up, down, left, and right sides and if the rotation is 3D, the theta value may be separated into three values.

Reference numeral 730 represents, for example, the screen changed after the input is received from the user. If the display is present on a scene displayed after the user rotates the picture as much as a theta (θ), the electronic device may correct the theta (θ) value moved to the left and rotated by using a map ID, an X axis 43 and a Y axis 745 of a picture to infer the position at which the display is present. For example, in the case in which the picture corresponding to the map ID originally included in the server moves to the right from the reference orientation by 3 (theta value), if it is assumed that a display is present at position (10, 10), when a user moves to the right by 4 (theta value), it may be inferred that the display is present at position (0, 10). In this case, the electronic device may display the thumbnail (picture, GIF, moving image) 735 associated with the screen of the display at an inferred position 740. On the other hand, when the theta movement from the reference orientation is made, if it is assumed that the display is present at the position that may not be displayed, the electronic device does not take any operation.

FIG. 7B is flow chart of a detailed operation of the electronic device for the method described with reference to FIG. 7A. The electronic device may transmit the positional information of the current electronic device to the server (S750). The electronic device may acquire a map ID corresponding to the positional information of the electronic device. In this case, the picture and the coordinate information on the display may be acquired from a separate map server based on the map ID (S755). The electronic device may display the received picture and the information on the display based on a predetermined reference orientation (S760). Next, the electronic device senses whether the user moves (S765) and when the movement of the user is sensed, coordinate values of the electronic device may be acquired after the user moves (S766). Next, the electronic device may correct the coordinate value of the display based on the acquired coordinate value (S767).

Next, the electronic device may determine whether the display is present on the current screen (S770). When the display is present on the current screen, the information on the display may be displayed at the coordinate value of the display (S780). The information on the display may include, for example, the thumbnail associated with the displayed image. Further, in the step 5770, when the display is not present on the current screen, the method may again return to step S765 to determine whether the movement of the user is sensed.

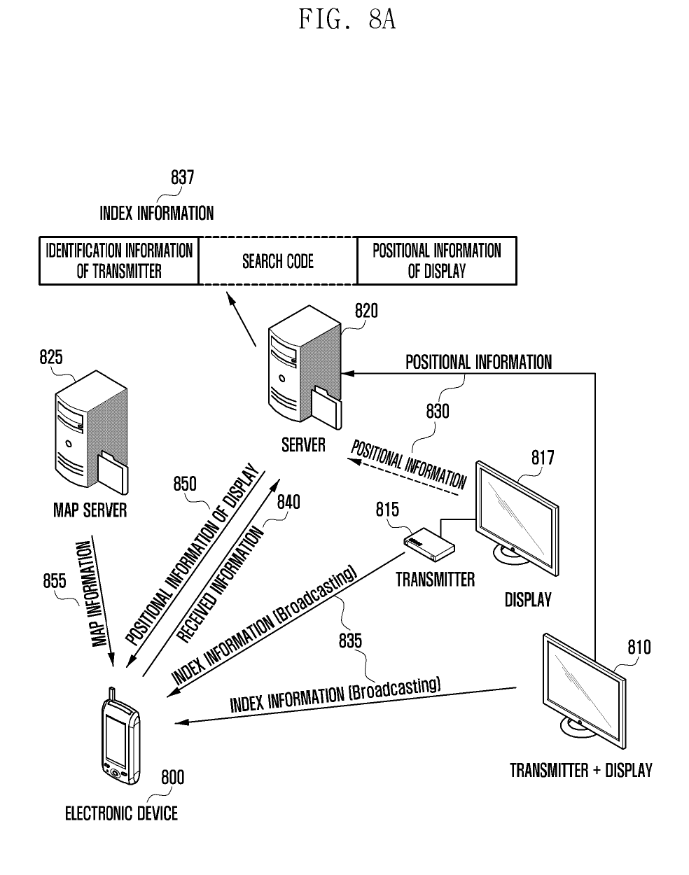

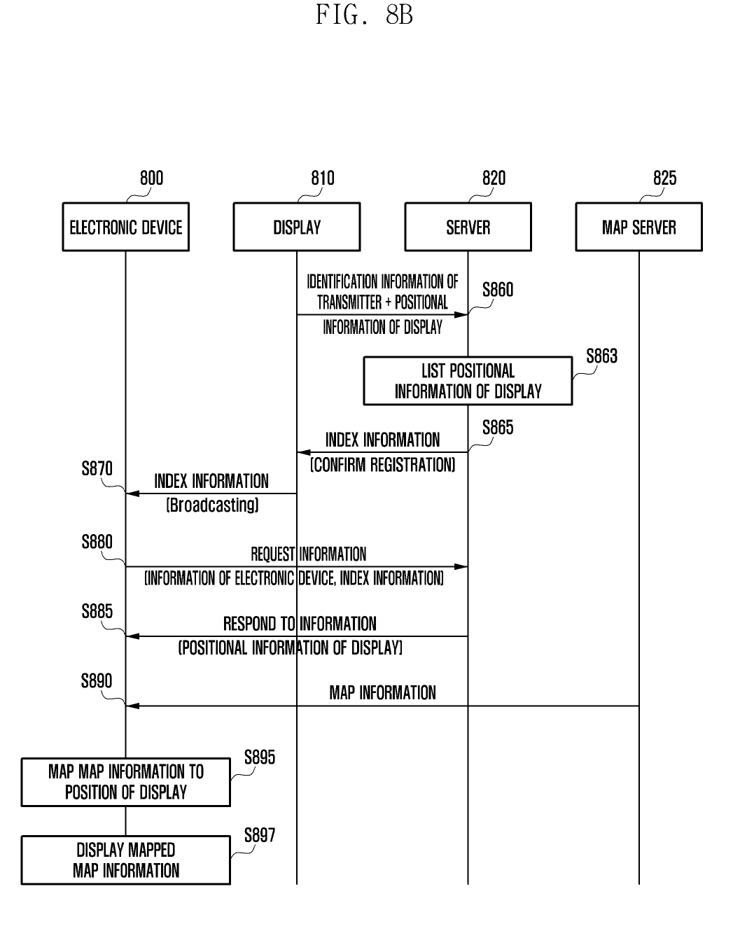

FIGS. 8 to 11 are diagrams illustrating a method for receiving, by an electronic device, a map and positional information of a display to allow the electronic device described with reference to FIGS. 6 and 7 to display the display using geographic information.

FIGS. 8A and 8B are diagrams illustrating a method for receiving map information from a separate map server by an electronic device to display a screen based on map information on a display according to another embodiment of the present disclosure.

Referring to FIG. 8A, the display may include a display 810 including a transmitter and a display 817 physically connected to a transmitter 815. Further, although not illustrated in FIG. 8A, the display may include a display that is present at a separate position from the transmitter. The display 810 including the transmitter and the transmitter 815 may transmit data associated with the display. The data associated with the display may include information associated with an image that is broadcast from the display. Further, the display 810 including the transmitter and the transmitter 815 may include a positioning module (e.g., GPS), or the like, if necessary.

Further, the server 820 may manage the display 810 including the transmitter and the transmitter 815. First, the server 820 may permit a transmission of a message of the display 810 including the transmitter and the transmitter 815. Further, the server 820 may receive positional information, or the like, from the display 810 including the transmitter and the transmitter 815 (830). The server 820 may include a list that includes the received positional information, information such as identification information, index information 837 generated for each display 810, or the like. Further, the server 820 may transmit the generated index information 837 to the corresponding display 810 and the transmitter 815. The electronic device 800 may receive the index information from the display 810 including the transmitter and the transmitter 815 (835). Next, the electronic device 800 may transmit the received information to the server 820 (840). Next, the electronic device 800 may receive content information 850 associated with the display from the server and receive map information from a map server 825.

The position of the display may be directly measured by the transmitter included in the display or the transmitter connected to the display, according to the embodiment. However, if the server previously knows the position of the display when the display is installed, the transmitter need not directly measure the positional information. However, when the transmitter moves while physically separated from the display, the position needs to be periodically measured depending on the given condition. In this case, when the positional information of the display is directly transmitted to a receiver, according to the embodiment, there are cases in which the display is indoors, the positional information is too long, or only the server knows the position without the transmitter including the positioning module, which may cause a problem. Therefore, the present disclosure may receive the positional information measured by the transmitter or generate the index information based on the information on the already known position of the transmitter, and then list and include the information.

Referring to FIG. 8B, the display 810 may transmit identification information on the transmitter included in the display 810 and positional information of the display 810, by including the identification information and the positional information in a registration request message (S860). The server 820 may register and list the positional information of the display in response to the received registration request message (S863). The server 820 may confirm authentication information based on the identification information on the transmitter when the registration is completed, register the positional information of the display, and then transmit the index information transmitted by the transmitter included in the display 810 to the display 810, by including the index information in a registration confirmation message (S865). The index information may include a search code, content, a hash code of the positional information of the display, a temporary ID of the transmitter, or the like.

Next, the display 810 may broadcast the received index information (S870). When the included information may not be analyzed, an electronic device 800 receiving the broadcast information may transmit an information request message to the server (S880). The information request message may include the information on the electronic device 800, the index information on the display, of the like.

When the server 820 receiving the information request message from the electronic device 800 compares the information request message with the included index information list to determine that the index of the display is present, the server 820 may transmit an information response message including the positional information of the display (S885). In this case, if additional information corresponding to the display is present, the server 820 may transmit the additional information by including the additional information in the information response message (S885). The additional information may include data associated with the screen displayed on the display 810. Alternatively, the information associated with the screen displayed on the display 810 may include an URL address that may receive the data associated with the screen, or the like.

Next, the map server 825 may transmit the map information to the electronic device 800. The electronic device may download the map information from the map server and then perform the operation of mapping the corresponding display 810 to the map based on the positional information of the display 810 received in the step 5885. Next, the electronic device 800 may display the map information mapped to the received positional information of the display on the screen (S897). If the input to select one of the displays displayed on the map information from the user is sensed, the electronic device 800 may directly receive data based on the information corresponding to the previously selected display. Alternatively, when receiving an URL address that may receive data associated with the screen, the electronic device 800 may access the specific contents provider server to receive the corresponding information.

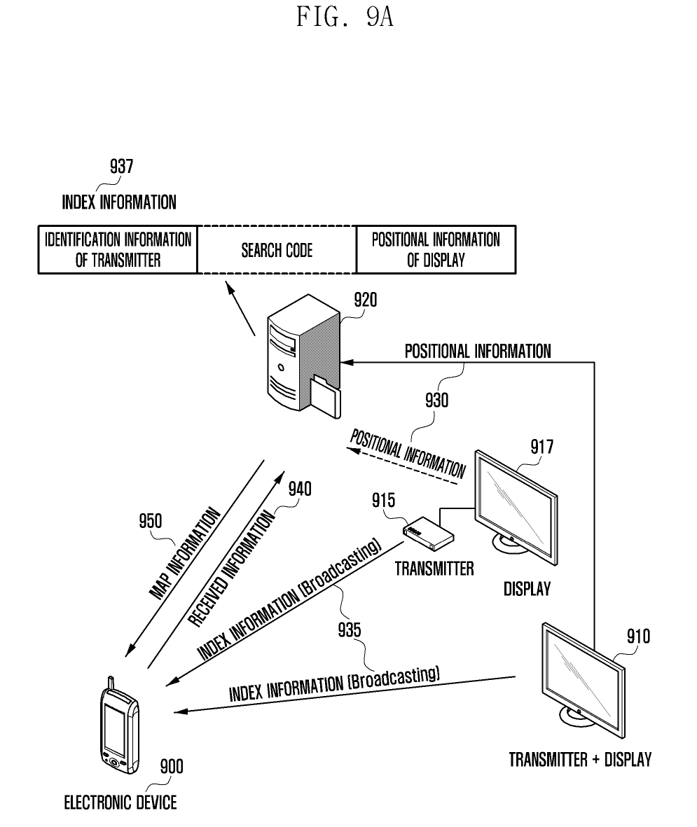

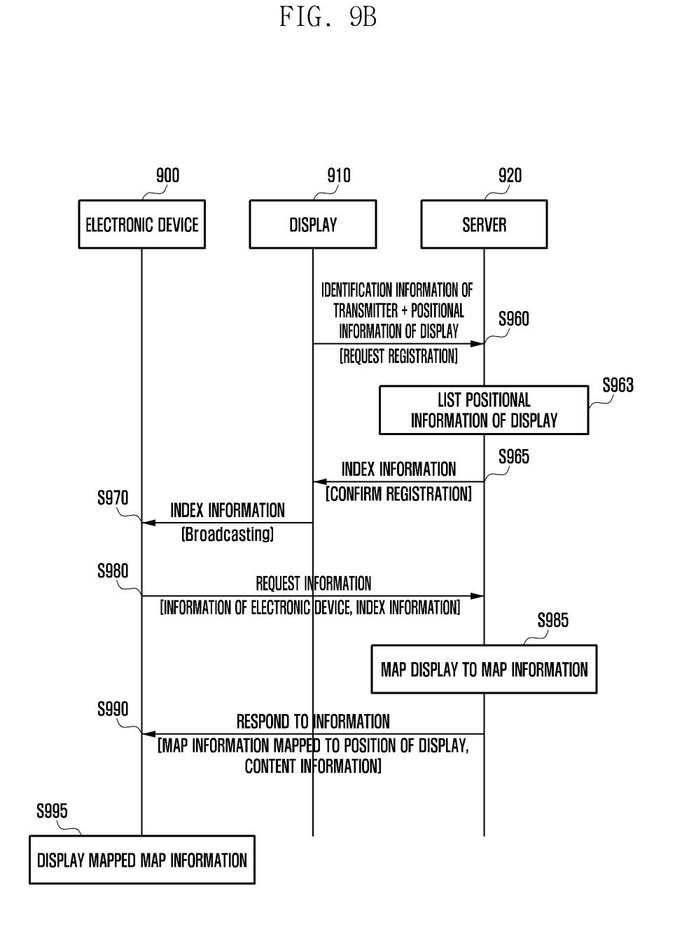

FIGS. 9A and 9B are diagrams illustrating a method for receiving map information including information on a display from a server by an electronic device to display a screen based on map information on the display according to another embodiment of the present disclosure.

In more detail, referring to FIG. 9A, unlike FIG. 8A, the server may know that the display transmits the mapped map information.

Referring to FIG. 9A, the display may include a display 910 including a transmitter and a display 917 physically connected to a transmitter 915. Further, although not illustrated in FIG. 9A, the display may include a display that is present at a separate position from the transmitter. The display 910 including the transmitter and the transmitter 915 may broadcast information associated with an image displayed on the display or transmit independent information. Further, the display may include the positioning module (e.g. GPS) if necessary.

Further, the server 920 may manage the display 910 including the transmitter and the transmitter 915. First, the server 920 may permit a transmission of a message of the display 910 including the transmitter and the transmitter 915. Further, the server 820 may receive positional information, or the like, from the display 910 including the transmitter and the transmitter 915 (930). When receiving the positional information of the display, the server 920 may perform the operation of displaying the corresponding display on the map based on the positional information of the corresponding display. The server 920 may include a list that includes the map information on which the received positional information of the display is displayed, the search code, and index information 937 generated for each display 910, or the like. Further, the server 920 may store the map information in advance. Further, the server 920 may transmit the generated index information 937 to the corresponding display 910 and the transmitter 915. The electronic device 900 may receive the index information from the display 910 including the transmitter and the transmitter 915 (935). Next, the electronic device 900 may transmit the received information to the server 920 (940). Next, the server 920 may transmit the map information to which the positional information of the corresponding display corresponding to the information received from the electronic device is mapped to the electronic device 900 (950).

The electronic device 900 may display the received map information on the screen. According to the embodiment, the position of the display may be directly measured by the transmitter included in the display or the transmitter connected to the display and if the server knows in advance that the display is installed, the transmitter need not measure the positional information. However, when the transmitter moves while physically separated from the display, the position needs to be periodically measured depending on the given condition. In this case, when the positional information of the display is directly transmitted to a receiver, according to the embodiment, there are cases in which the display is indoors, the positional information is too long, or only the server knows the position without the transmitter including the positioning module, which may cause a problem. Therefore, the present disclosure may receive the positional information measured by the transmitter or generate the index information based on the information on the already known position of the transmitter, and then list and include the information.

Referring to FIG. 9B, the display 910 may transmit identification information on the transmitter included in the display 910 and positional information of the display 910, by including the identification information and the positional information in a registration request message (S960). The server 920 may register and list the positional information of the display in response to the received registration request message (S963). When receiving the positional information of the display, the server 920 may perform the operation of displaying the corresponding display on the map based on the positional information of the corresponding display. The server 920 may confirm authentication information based on the identification information on the transmitter when the registration is completed, register the positional information of the display, and then transmit the index information transmitted by the transmitter included in the display 910 to the display 910, by including the index information in a registration confirmation message (S965). The index information may include the map information representing the received positional information of the display, the search code, or the identification information. The index information may include content, a hash code of the positional information of the display, a temporary ID of the transmitter, or the like.

Next, the display 910 may broadcast the received index information. When the included information may not be analyzed, an electronic device 900 receiving the broadcast information may transmit an information request message to the server (S980). The information request message may include the information on the electronic device 900, the index information on the display, of the like. Next, when the server 920 compares with the included list of the index information to determine that the index of the display is present, the server 920 may perform the operation of mapping the positional information of the display to the pre-stored map information (S985). Next, the map information mapped to the positional information of the display may be transmitted to the electronic device 900 by being included in the information response message (S990). In this case, if additional information corresponding to the display is present, the server 920 may transmit the additional information by including the additional information in the information response message. The additional information may include data associated with the screen displayed on the display 910. Alternatively, the information associated with the screen displayed on the display 910 may include an URL address that may receive the data associated with the screen, or the like.

Next, the electronic device 900 may display the map information mapped to the received positional information of the display on the screen (S995). If the input to select one of the displays displayed on the map information from the user is sensed, the electronic device 900 may directly receive data based on the information corresponding to the previously selected display. Alternatively, when receiving an URL address that may receive data associated with the screen, the electronic device 900 may access the specific contents provider server to receive the corresponding information.

Generally, the embodiments described with reference to FIGS. 8 and 9 may be used in the case like the outside that may obtain the positional information of the display. Hereinafter, unlike this, an embodiment that may be applied to the case like the inside that may not obtain the direct positional information from the display will be described.

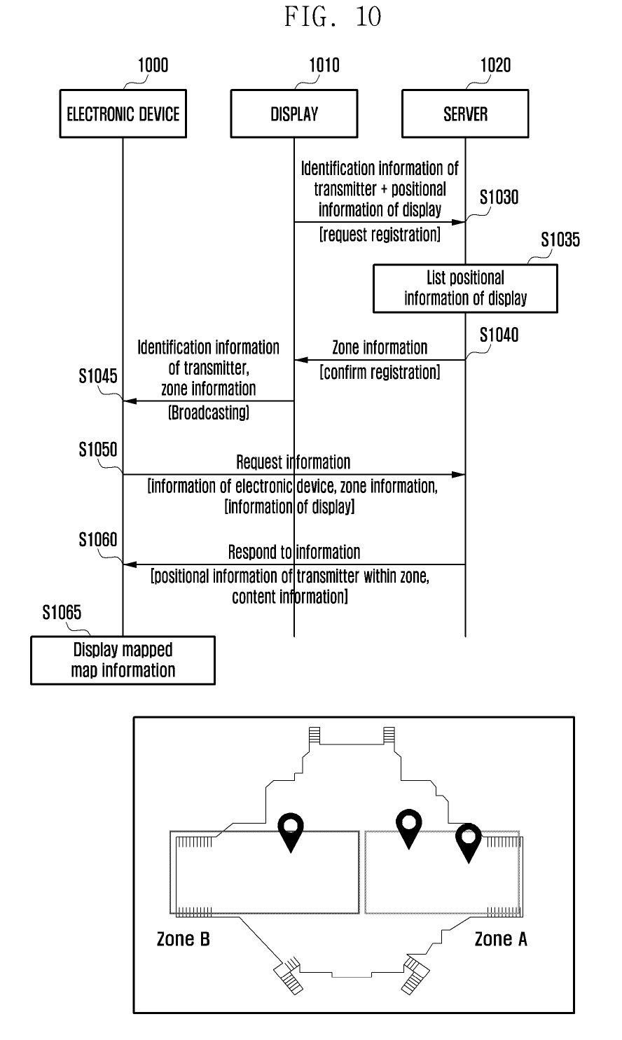

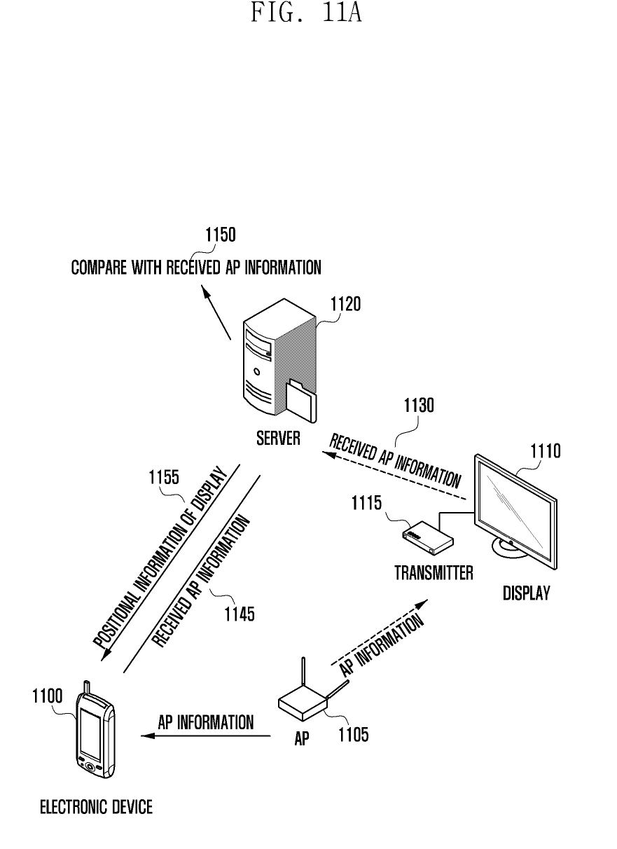

FIG. 10 is a diagram illustrating a method for displaying a screen based on map information on a display using zone information on the display by an electronic device according to another embodiment of the present disclosure.

Referring to FIG. 10, a display 1010 may transmit identification information on a transmitter included in the display 1010 and positional information of the display 1010 to a server, by including the identification information and the positional information in a registration request message (S1030). The positional information of the display 1010 may include information on a place where the display 1010 is installed in a predetermined zone. The server 1020 may register and list the positional information of the display in response to the received registration request message (S1035). The server 1020 may confirm authentication information based on the identification information on the transmitter when the registration is completed, register the positional information of the display, and then transmit the zone information transmitted by the transmitter included in the display 1010 to the display 1010, by including the zone information in a registration confirmation message (S1040).

Next, the display 1010 may broadcast the received information (S1045). When the included information may not be analyzed, an electronic device 1000 receiving the broadcast information may transmit an information request message to the server (S1050). The information request message may include the information on the electronic device 1010, the zone information on the display, of the like. Next, the server 1020 may transmit the positional information of the display within a zone corresponding to the received zone information in the pre-stored map information or the display may transmit the map information mapped to the zone of the display by including the map information in the information response message (S1060). In this case, if additional information corresponding to the display is present, the server 1020 may transmit the additional information by including the additional information in the information response message. The additional information may include data associated with the screen displayed on the display 1010. Alternatively, the information associated with the screen displayed on the display 1010 may include an URL address that may receive the data associated with the screen, or the like.

When the display receives the map information mapped to the zone, the electronic device 1000 may display the map information to which the received positional information of the display is mapped on the screen (S1065). Although not illustrated in FIG. 10, when only the positional information of the display within the zone is received, the operation of mapping the corresponding display 1010 to the map based on the zone information on the display receiving the zone information in the step S1045 may be performed and the mapped map information may be displayed on the screen. If the input to select one of the displays displayed on the map information from the user is sensed, the electronic device 1000 may directly receive data based on the information corresponding to the previously selected display. Alternatively, when receiving an URL address that may receive data associated with the screen, the electronic device 1000 may access the specific contents provider server to receive the corresponding information.

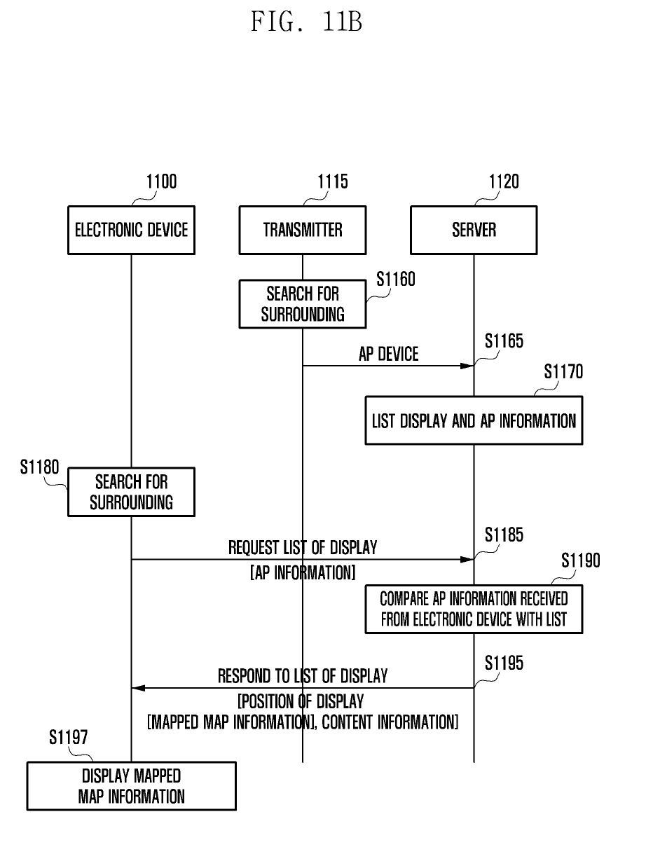

FIGS. 11A and 11B are diagrams illustrating a method for displaying a screen based on map information on a display using an access point (AP) that is indoors by an electronic device according to another embodiment of the present disclosure.

Referring to FIG. 11A, for convenience, a display 1110 connected to a transmitter 1115 will be described as an example. Although not illustrated in FIG. 11A, the present disclosure may be applied even to the display including the transmitter. First, the transmitter 1115 may search for an AP 1105 therearound to transmit the received AP information to the server 1120 (1130). Further, the electronic device 1100 may search for the AP 1105 therearound to transmit the received AP information to the server 1120. The server 1120 may compare the AP information received from the transmitter 1115 with the AP information received from the electronic device 1100 (1150). According to the comparison result, the positional information of the display may be transmitted to the electronic device 1100 (1155).

In FIG. 11B, the operation among the electronic device 1100, the transmitter 1115 connected to the display, and the server 1120 will be described in more detail.

First, the transmitter 1150 may search for the AP therearound to receive the AP information (S1160). Next, the transmitter 1115 may upload the authenticated identification information and the received AP information to the server 1120 based on the registration request message. According to the embodiment, the transmitter 1115 may upload information such as a service set identifier of the AP therearound and a received signal strength indicator (RSSI) to the server. The operation may be periodically performed according to the embodiment.

The server 1120 may generate a list using the identification information and the AP information (S1170). Next, the electronic device 1100 may search for the AP therearound (S1180) and transmit the searched and received AP information to the server 1120 by including the AP information in a list request message. Next, the electronic device 1100 may acquire and transmit the SSID, the RSSI, or the like of the AP therearound. Next, the server 1120 compares the AP information received from the electronic device 1100 with the AP information on the transmitter that is included in the list generated in the step S1170. If there is the transmitter that transmits the AP information matched to the AP information transmitted by the electronic device 1100, the list of the display associated with the transmitter may be transmitted to the electronic device (S1195). Next, the user may select the transmitter and receive the corresponding information.

In addition, when the transmitter and the electronic device are indoors, according to another embodiment, the position of the transmitter and the electronic device may be acquired by using another terminal of which the position is defined in advance. For example, another terminal may infer its own position by a method (e.g. triangulation) for receiving positional information of an indoor map, signal strength, time, or the like and measuring the same. According to another embodiment, any fixed transmitter may transmit its own information and information such as signal strength and time to the server. Next, the server may map the received information to the map having the information on the fixed transmitter and store it. Next, the server may infer the position based on the signal strength received from the transmitter and the electronic device to transmit the positional information. The server may understand the positions of each transmitter and the electronic device and then transmit the map information to which the transmitter and the electronic device of which the positions are determined are mapped to the electronic device of the user.

According to another embodiment, the positions of the transmitter and the electronic device may be acquired using an RF map. The RF map means data obtained by measuring signal strength of a radio wave depending on a geographical feature or a position, noise depending on interference, or the like and mapping them to the map. The RF map is prepared by periodically patrolling and measuring a special vehicle and collecting the measurement for the agreed terminal. The transmitter and the electronic device may infer the position based on the signal strength of the radio wave or the noise that is measured using the RF map. The server may determine the positions of each transmitter and the electronic device and then transmit the map information to which the transmitter and the electronic device of which the positions are determined are mapped to the electronic device of the user.

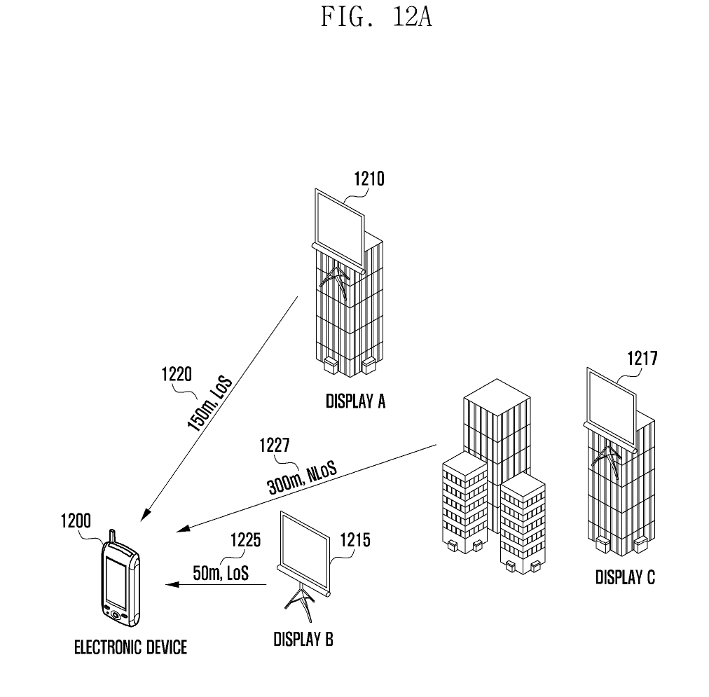

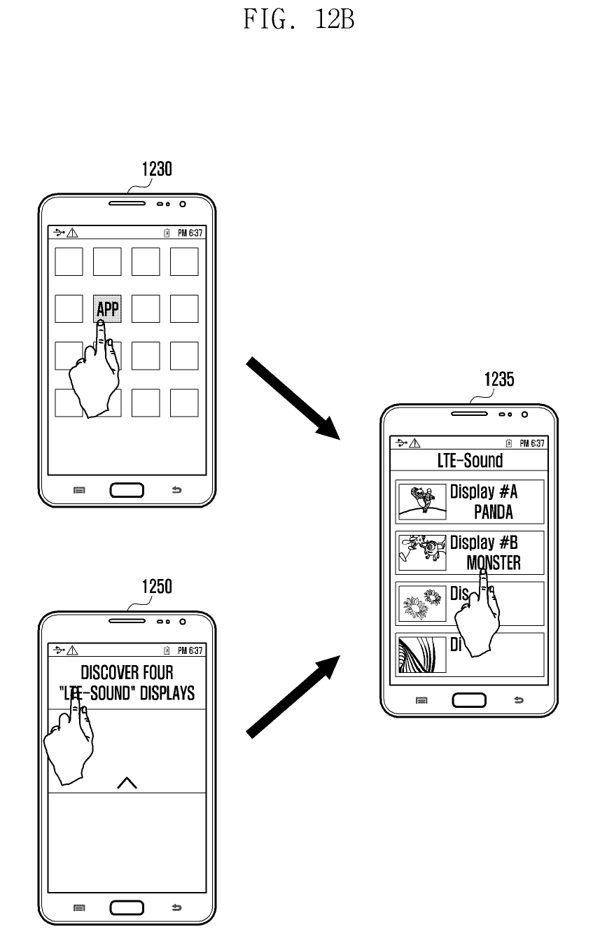

FIGS. 12A and 12B are diagram illustrating a method for determining and display priority between a plurality of displays by an electronic device according to another embodiment of the present disclosure.

In more detail, FIG. 12A illustrates priority of the display in consideration of a distance of the display with respect to the electronic device as well as a line of sight of the display, when there is at least one display around the electronic device. The display may be positioned in a line of sight (LoS) from the electronic device and may be positioned in a non-line of sight (NLoS) area.

For example, a display A 1210 may be positioned in the line of sight (LoS) of a point of 150 m from the electronic device 1200 and a display B 1215 may be positioned in the line of sight (LoS) of a point of 50 m. Further, a display C 1217 may be positioned in a non-line of sight (NLoS) of a point of 300 m.

In this scenario, for convenience of a user, the electronic device requires a method for determining a display expected to have high selection priority and displaying information on the display. For this purpose, to determine priority for a plurality of displays, at least one of the distance information between the electronic device and the display, the LoS information, or the information on the display that is in a progress direction of the electronic device may be considered.

FIG. 12B is a diagram illustrating that the electronic device displays the information on the display in consideration of the priority of the display, when at least one display is present around the electronic device in the case in which the electronic device includes a display that displays the user interface (UI).

First, when at least one display around the electronic device is sensed, the information on the display may be displayed. In this case, there may be a method 1230 for displaying when a user performs triggering by the method for displaying information on a display and a method 1250 for displaying when an input of a user is present after alert using an upper alert window. The methods 1230 and 1250 illustrated are the same as the method described in the method 600 and 605 of FIG. 6.

The electronic device may sense the triggering of the user or may display the information on at least one display when the input of the user is sensed after alert using the upper alert window (1235). In this case, the electronic device may display the information on the display in consideration of priorities for each display. That is, the order of the displays may be disposed and displayed according to the priority (1235). Next, when the user senses the input to select the information on the displayed display, the electronic device may receive and reproduce the displayed related information as described in FIG. 6.

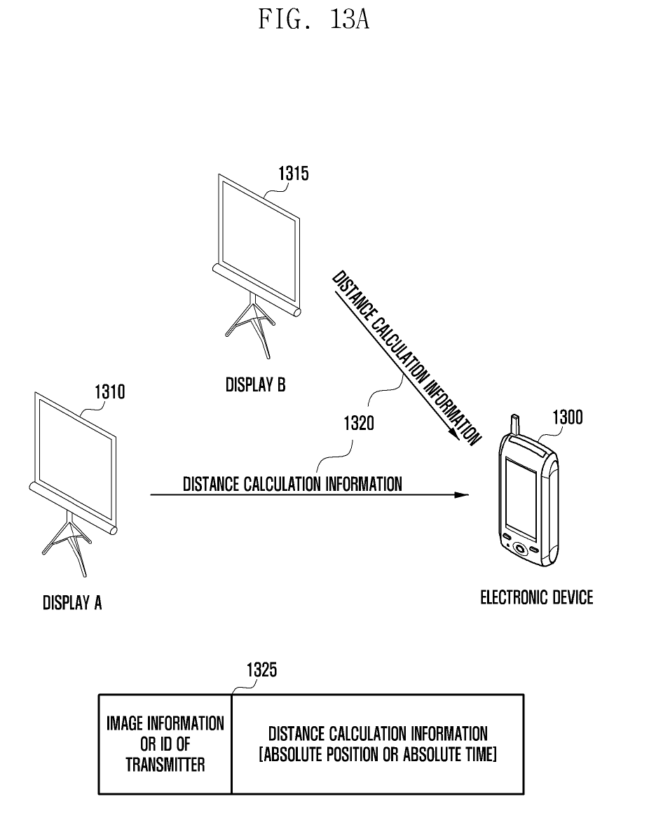

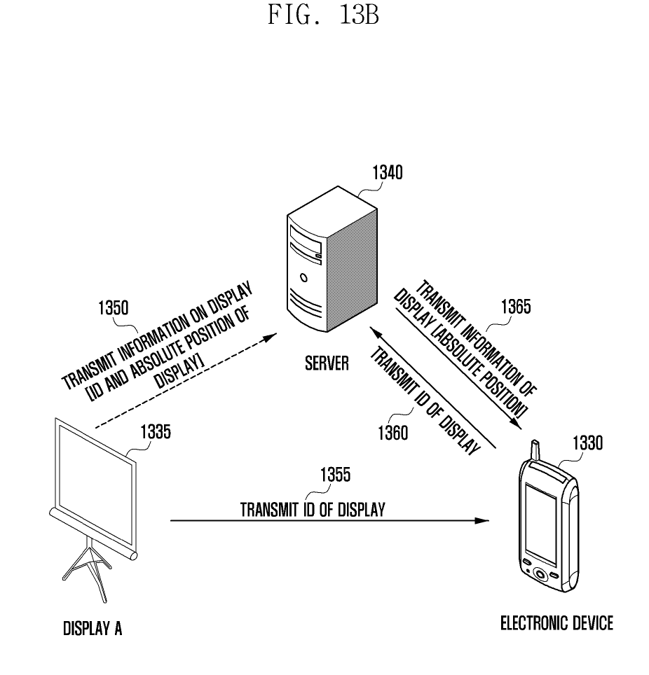

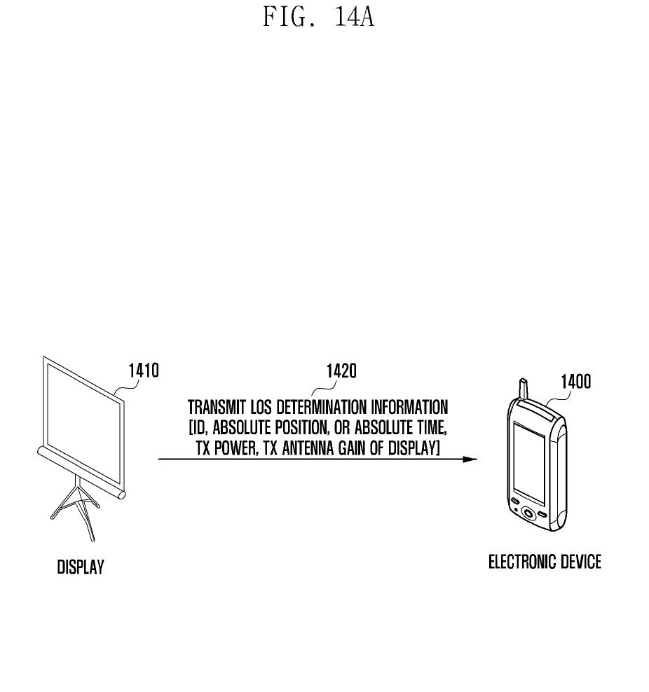

FIGS. 13A and 13B are diagrams illustrating a method for acquiring, by an electronic device, distance calculation information for determining priority between a plurality of displays used to select the display according to another embodiment of the present disclosure.

In more detail, FIG. 13A is a diagram illustrating a method for directly receiving information from a display in the method for acquiring, by an electronic device, distance calculation information of a display.

A display A 1310 and a display B 1315 may transmit a message, including the distance calculation information when the message is transmitted to an electronic device 1300 (1320). The distance calculation information may include at least one of absolute time information and absolute position information. The display may transmit the distance calculation information when transmitting image information to transmit the information for the distance calculation or the distance calculation information when transmitting data, by a method for transmitting distance calculation information proposed in the present disclosure. Alternatively, only the identification information of the display and the information for the distance calculation may be separately transmitted (1325).

The absolute position information may be acquired by using global positioning system (GPS) information using a satellite or a triangulation using positioning of a base station. The absolute time information may use time of the base station in synchronization or confirm or acquire the absolute time information according to another embodiment. The method for acquiring absolute position information and absolute time information as described above corresponds to the embodiment described in the present disclosure and therefore the absolute position information and the absolute time information may be acquired by another method. The display and the electronic device may confirm the absolute position information and the absolute time information by the method.

According to the embodiment of the present disclosure, if the displays 1310 and 1315 transmit the absolute position of the display to the electronic device 1300, the electronic device may receive the absolute position information of the display and confirm the absolute position of the display. The electronic device may know the distance between the electronic device and the display using the absolute positions of the electronic device and the display.

According to another embodiment of the present disclosure, if the displays 1310 and 1315 transmit the absolute time of the display to the electronic device 1300, the electronic device may receive the absolute time information of the display to know the distance based on the time difference between the screen display device and the electronic device.

By the foregoing example, the electronic device 1300 may confirm that the distance from the display A 1310 is 100 m based on the information transmitted for distance calculation from the display A 1310. When the electronic device 1300 confirms that the distance from the display is 50 m based on the absolute position information transmitted from the display B 1320, the electronic device 1300 may preferentially display the information on the display B or select and display the display B having the higher priority.

FIG. 13B is a diagram illustrating a method for receiving absolute position information on a display from a server in the method for acquiring, by an electronic device, distance calculation information of a display.

In more detail, a display 1335 may transmit the information on the display including the ID of the display and the absolute position of the display to a server 1340. The display 1350 may transmit the absolute position information acquired by the method described in FIG. 13A to the server, along with the ID of the display. The server 1340 may store the ID and the absolute position information of the display that is received from the display. Next, the display 1335 may transmit the ID 1355 of the display to the electronic device 1330. When receiving the ID of the display 1335, the electronic device 1330 may transmit the ID of the display to the server 1340 (1360). The server 1340 may transmit the absolute position information matching the ID of the display device to the electronic device 1330 (1365).

The electronic device 1330 may confirm the distance between the display and the electronic device using the absolute position of the display and the absolute position of the electronic device that are received from the server 1340. Next, the priority of the plurality of displays may be determined based on the confirmed distance information. Determining, by the electronic device 1330, the priority between the plurality of displays and then displaying the information on the display on the screen based on the priority are the same as one described in FIG. 13A.

In addition, the method described with reference to FIG. 13A may be applied to determining the priority between the selected displays when the plurality of displays are selected according to the embodiments described with reference to FIGS. 1 to 5. Further, the embodiments described with reference to FIGS. 6 to 11 may be applied to determining the priority between the respective displays displayed on the screen and displaying the displays together.

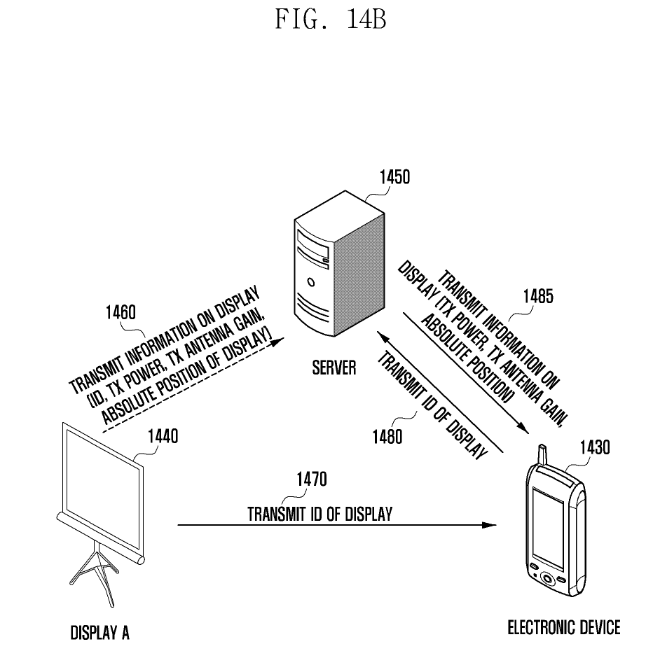

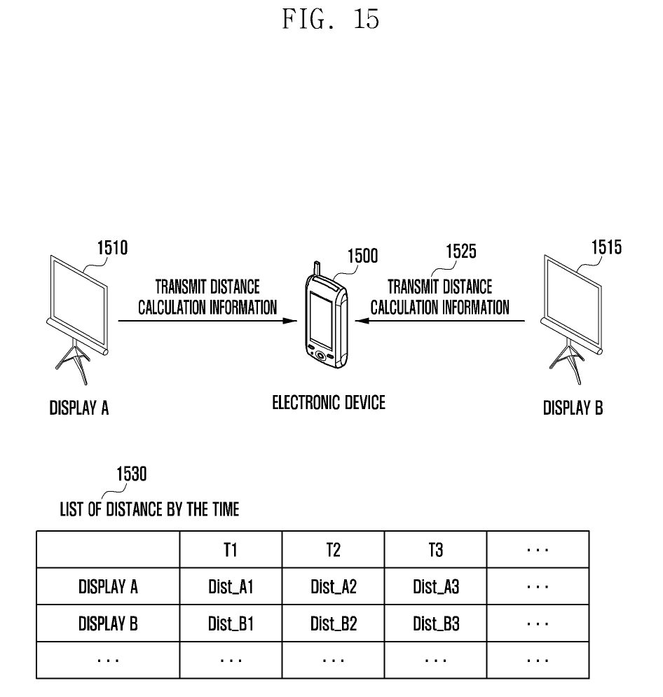

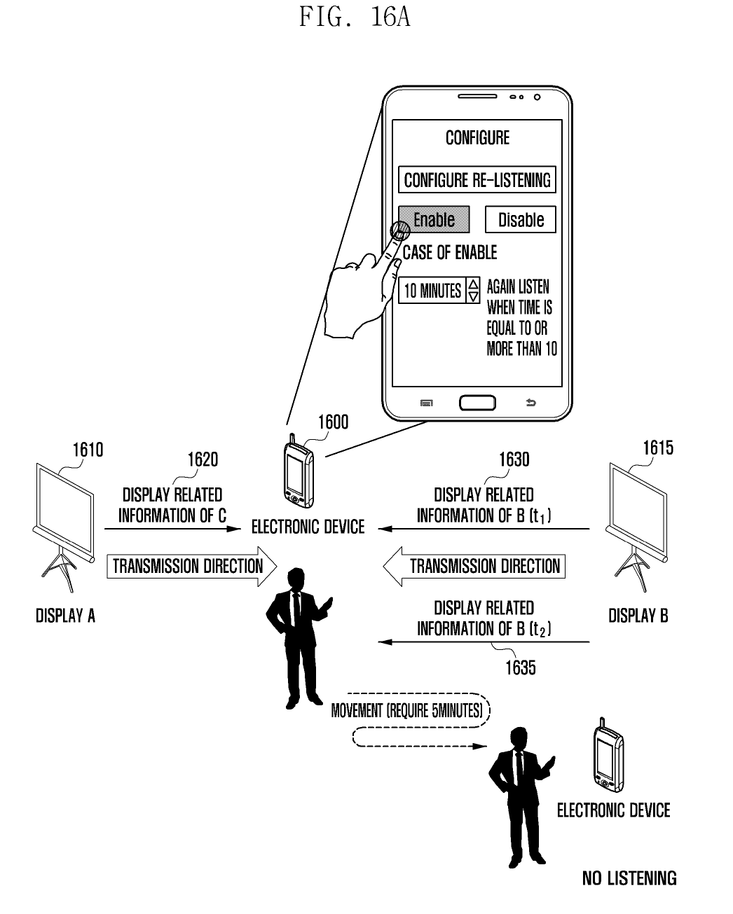

FIGS. 14A and 14B are diagrams illustrating a method for acquiring, by an electronic device, line of sight determination information for determining priority between a plurality of displays according to another embodiment of the present disclosure.

In more detail, FIG. 14A is a diagram illustrating the case in which the electronic device directly receives the line of sight determination information from the display.

A display 1410 may transmit LOS determination information to an electronic device 1400 by the method proposed in the present disclosure (1420). The LoS determination information may include the absolute position of the display or the absolute time of the display and may further include transmit power (Tx power) of the display and a Tx antenna gain of the display. The electronic device 1400 may confirm the distance based on the absolute time or the absolute position of the screen by the method described with reference to FIG. 13A.

Further, the electronic device 1400 may use the following method to know whether the display 1410 is in an LoS state. The electronic device 1400 may confirm the distance between the display and the electronic device based on the absolute position or the absolute time of the display, as described with reference to FIG. 13A. Next, the electronic device 1400 may know receive power Pe_rx that needs to be received in the case of the LoS, based on the Tx antenna gain and the receive power of the electronic device. For example, the power Pe_rx that needs to be received in the case of the LoS may be calculated based on the Tx antenna gain of the display, the power of the display, a path loss between the display and the electronic device, and the calculation of the Tx antenna gain of the electronic device. Further, the electronic device 1400 may use the distance information calculated based on the absolute position or the absolute time of the display to obtain the path loss between the display and the electronic device.

FIG. 7B is flow chart of a detailed operation of the electronic device for the method described with reference to FIG. 7A. The electronic device may transmit the positional information of the current electronic device to the server (S750). The electronic device may acquire a map ID corresponding to the positional information of the electronic device. In this case, the picture and the coordinate information on the display may be acquired from a separate map server based on the map ID (S755). The electronic device may display the received picture and the information on the display based on a predetermined reference orientation (S760). Next, the electronic device senses whether the user moves (S765) and when the movement of the user is sensed, coordinate values of the electronic device may be acquired after the user moves (S766). Next, the electronic device may correct the coordinate value of the display based on the acquired coordinate value (S767).

Next, the electronic device may determine whether the display is present on the current screen (S770). When the display is present on the current screen, the information on the display may be displayed at the coordinate value of the display (S780). The information on the display may include, for example, the thumbnail associated with the displayed image. Further, in the step 5770, when the display is not present on the current screen, the method may again return to step S765 to determine whether the movement of the user is sensed.

FIGS. 8 to 11 are diagrams illustrating a method for receiving, by an electronic device, a map and positional information of a display to allow the electronic device described with reference to FIGS. 6 and 7 to display the display using geographic information.

FIGS. 8A and 8B are diagrams illustrating a method for receiving map information from a separate map server by an electronic device to display a screen based on map information on a display according to another embodiment of the present disclosure.

Referring to FIG. 8A, the display may include a display 810 including a transmitter and a display 817 physically connected to a transmitter 815. Further, although not illustrated in FIG. 8A, the display may include a display that is present at a separate position from the transmitter. The display 810 including the transmitter and the transmitter 815 may transmit data associated with the display. The data associated with the display may include information associated with an image that is broadcast from the display. Further, the display 810 including the transmitter and the transmitter 815 may include a positioning module (e.g., GPS), or the like, if necessary.

Further, the server 820 may manage the display 810 including the transmitter and the transmitter 815. First, the server 820 may permit a transmission of a message of the display 810 including the transmitter and the transmitter 815. Further, the server 820 may receive positional information, or the like, from the display 810 including the transmitter and the transmitter 815 (830). The server 820 may include a list that includes the received positional information, information such as identification information, index information 837 generated for each display 810, or the like. Further, the server 820 may transmit the generated index information 837 to the corresponding display 810 and the transmitter 815. The electronic device 800 may receive the index information from the display 810 including the transmitter and the transmitter 815 (835). Next, the electronic device 800 may transmit the received information to the server 820 (840). Next, the electronic device 800 may receive content information 850 associated with the display from the server and receive map information from a map server 825.

The position of the display may be directly measured by the transmitter included in the display or the transmitter connected to the display, according to the embodiment. However, if the server previously knows the position of the display when the display is installed, the transmitter need not directly measure the positional information. However, when the transmitter moves while physically separated from the display, the position needs to be periodically measured depending on the given condition. In this case, when the positional information of the display is directly transmitted to a receiver, according to the embodiment, there are cases in which the display is indoors, the positional information is too long, or only the server knows the position without the transmitter including the positioning module, which may cause a problem. Therefore, the present disclosure may receive the positional information measured by the transmitter or generate the index information based on the information on the already known position of the transmitter, and then list and include the information.

Referring to FIG. 8B, the display 810 may transmit identification information on the transmitter included in the display 810 and positional information of the display 810, by including the identification information and the positional information in a registration request message (S860). The server 820 may register and list the positional information of the display in response to the received registration request message (S863). The server 820 may confirm authentication information based on the identification information on the transmitter when the registration is completed, register the positional information of the display, and then transmit the index information transmitted by the transmitter included in the display 810 to the display 810, by including the index information in a registration confirmation message (S865). The index information may include a search code, content, a hash code of the positional information of the display, a temporary ID of the transmitter, or the like.

Next, the display 810 may broadcast the received index information (S870). When the included information may not be analyzed, an electronic device 800 receiving the broadcast information may transmit an information request message to the server (S880). The information request message may include the information on the electronic device 800, the index information on the display, of the like.

When the server 820 receiving the information request message from the electronic device 800 compares the information request message with the included index information list to determine that the index of the display is present, the server 820 may transmit an information response message including the positional information of the display (S885). In this case, if additional information corresponding to the display is present, the server 820 may transmit the additional information by including the additional information in the information response message (S885). The additional information may include data associated with the screen displayed on the display 810. Alternatively, the information associated with the screen displayed on the display 810 may include an URL address that may receive the data associated with the screen, or the like.

Next, the map server 825 may transmit the map information to the electronic device 800. The electronic device may download the map information from the map server and then perform the operation of mapping the corresponding display 810 to the map based on the positional information of the display 810 received in the step 5885. Next, the electronic device 800 may display the map information mapped to the received positional information of the display on the screen (S897). If the input to select one of the displays displayed on the map information from the user is sensed, the electronic device 800 may directly receive data based on the information corresponding to the previously selected display. Alternatively, when receiving an URL address that may receive data associated with the screen, the electronic device 800 may access the specific contents provider server to receive the corresponding information.

FIGS. 9A and 9B are diagrams illustrating a method for receiving map information including information on a display from a server by an electronic device to display a screen based on map information on the display according to another embodiment of the present disclosure.

In more detail, referring to FIG. 9A, unlike FIG. 8A, the server may know that the display transmits the mapped map information.

Referring to FIG. 9A, the display may include a display 910 including a transmitter and a display 917 physically connected to a transmitter 915. Further, although not illustrated in FIG. 9A, the display may include a display that is present at a separate position from the transmitter. The display 910 including the transmitter and the transmitter 915 may broadcast information associated with an image displayed on the display or transmit independent information. Further, the display may include the positioning module (e.g. GPS) if necessary.

Further, the server 920 may manage the display 910 including the transmitter and the transmitter 915. First, the server 920 may permit a transmission of a message of the display 910 including the transmitter and the transmitter 915. Further, the server 820 may receive positional information, or the like, from the display 910 including the transmitter and the transmitter 915 (930). When receiving the positional information of the display, the server 920 may perform the operation of displaying the corresponding display on the map based on the positional information of the corresponding display. The server 920 may include a list that includes the map information on which the received positional information of the display is displayed, the search code, and index information 937 generated for each display 910, or the like. Further, the server 920 may store the map information in advance. Further, the server 920 may transmit the generated index information 937 to the corresponding display 910 and the transmitter 915. The electronic device 900 may receive the index information from the display 910 including the transmitter and the transmitter 915 (935). Next, the electronic device 900 may transmit the received information to the server 920 (940). Next, the server 920 may transmit the map information to which the positional information of the corresponding display corresponding to the information received from the electronic device is mapped to the electronic device 900 (950).

The electronic device 900 may display the received map information on the screen. According to the embodiment, the position of the display may be directly measured by the transmitter included in the display or the transmitter connected to the display and if the server knows in advance that the display is installed, the transmitter need not measure the positional information. However, when the transmitter moves while physically separated from the display, the position needs to be periodically measured depending on the given condition. In this case, when the positional information of the display is directly transmitted to a receiver, according to the embodiment, there are cases in which the display is indoors, the positional information is too long, or only the server knows the position without the transmitter including the positioning module, which may cause a problem. Therefore, the present disclosure may receive the positional information measured by the transmitter or generate the index information based on the information on the already known position of the transmitter, and then list and include the information.

Referring to FIG. 9B, the display 910 may transmit identification information on the transmitter included in the display 910 and positional information of the display 910, by including the identification information and the positional information in a registration request message (S960). The server 920 may register and list the positional information of the display in response to the received registration request message (S963). When receiving the positional information of the display, the server 920 may perform the operation of displaying the corresponding display on the map based on the positional information of the corresponding display. The server 920 may confirm authentication information based on the identification information on the transmitter when the registration is completed, register the positional information of the display, and then transmit the index information transmitted by the transmitter included in the display 910 to the display 910, by including the index information in a registration confirmation message (S965). The index information may include the map information representing the received positional information of the display, the search code, or the identification information. The index information may include content, a hash code of the positional information of the display, a temporary ID of the transmitter, or the like.

Next, the display 910 may broadcast the received index information. When the included information may not be analyzed, an electronic device 900 receiving the broadcast information may transmit an information request message to the server (S980). The information request message may include the information on the electronic device 900, the index information on the display, of the like. Next, when the server 920 compares with the included list of the index information to determine that the index of the display is present, the server 920 may perform the operation of mapping the positional information of the display to the pre-stored map information (S985). Next, the map information mapped to the positional information of the display may be transmitted to the electronic device 900 by being included in the information response message (S990). In this case, if additional information corresponding to the display is present, the server 920 may transmit the additional information by including the additional information in the information response message. The additional information may include data associated with the screen displayed on the display 910. Alternatively, the information associated with the screen displayed on the display 910 may include an URL address that may receive the data associated with the screen, or the like.

Next, the electronic device 900 may display the map information mapped to the received positional information of the display on the screen (S995). If the input to select one of the displays displayed on the map information from the user is sensed, the electronic device 900 may directly receive data based on the information corresponding to the previously selected display. Alternatively, when receiving an URL address that may receive data associated with the screen, the electronic device 900 may access the specific contents provider server to receive the corresponding information.

Generally, the embodiments described with reference to FIGS. 8 and 9 may be used in the case like the outside that may obtain the positional information of the display. Hereinafter, unlike this, an embodiment that may be applied to the case like the inside that may not obtain the direct positional information from the display will be described.

FIG. 10 is a diagram illustrating a method for displaying a screen based on map information on a display using zone information on the display by an electronic device according to another embodiment of the present disclosure.

Referring to FIG. 10, a display 1010 may transmit identification information on a transmitter included in the display 1010 and positional information of the display 1010 to a server, by including the identification information and the positional information in a registration request message (S1030). The positional information of the display 1010 may include information on a place where the display 1010 is installed in a predetermined zone. The server 1020 may register and list the positional information of the display in response to the received registration request message (S1035). The server 1020 may confirm authentication information based on the identification information on the transmitter when the registration is completed, register the positional information of the display, and then transmit the zone information transmitted by the transmitter included in the display 1010 to the display 1010, by including the zone information in a registration confirmation message (S1040).

Next, the display 1010 may broadcast the received information (S1045). When the included information may not be analyzed, an electronic device 1000 receiving the broadcast information may transmit an information request message to the server (S1050). The information request message may include the information on the electronic device 1010, the zone information on the display, of the like. Next, the server 1020 may transmit the positional information of the display within a zone corresponding to the received zone information in the pre-stored map information or the display may transmit the map information mapped to the zone of the display by including the map information in the information response message (S1060). In this case, if additional information corresponding to the display is present, the server 1020 may transmit the additional information by including the additional information in the information response message. The additional information may include data associated with the screen displayed on the display 1010. Alternatively, the information associated with the screen displayed on the display 1010 may include an URL address that may receive the data associated with the screen, or the like.

When the display receives the map information mapped to the zone, the electronic device 1000 may display the map information to which the received positional information of the display is mapped on the screen (S1065). Although not illustrated in FIG. 10, when only the positional information of the display within the zone is received, the operation of mapping the corresponding display 1010 to the map based on the zone information on the display receiving the zone information in the step S1045 may be performed and the mapped map information may be displayed on the screen. If the input to select one of the displays displayed on the map information from the user is sensed, the electronic device 1000 may directly receive data based on the information corresponding to the previously selected display. Alternatively, when receiving an URL address that may receive data associated with the screen, the electronic device 1000 may access the specific contents provider server to receive the corresponding information.

FIGS. 11A and 11B are diagrams illustrating a method for displaying a screen based on map information on a display using an access point (AP) that is indoors by an electronic device according to another embodiment of the present disclosure.

Referring to FIG. 11A, for convenience, a display 1110 connected to a transmitter 1115 will be described as an example. Although not illustrated in FIG. 11A, the present disclosure may be applied even to the display including the transmitter. First, the transmitter 1115 may search for an AP 1105 therearound to transmit the received AP information to the server 1120 (1130). Further, the electronic device 1100 may search for the AP 1105 therearound to transmit the received AP information to the server 1120. The server 1120 may compare the AP information received from the transmitter 1115 with the AP information received from the electronic device 1100 (1150). According to the comparison result, the positional information of the display may be transmitted to the electronic device 1100 (1155).

In FIG. 11B, the operation among the electronic device 1100, the transmitter 1115 connected to the display, and the server 1120 will be described in more detail.

First, the transmitter 1150 may search for the AP therearound to receive the AP information (S1160). Next, the transmitter 1115 may upload the authenticated identification information and the received AP information to the server 1120 based on the registration request message. According to the embodiment, the transmitter 1115 may upload information such as a service set identifier of the AP therearound and a received signal strength indicator (RSSI) to the server. The operation may be periodically performed according to the embodiment.

The server 1120 may generate a list using the identification information and the AP information (S1170). Next, the electronic device 1100 may search for the AP therearound (S1180) and transmit the searched and received AP information to the server 1120 by including the AP information in a list request message. Next, the electronic device 1100 may acquire and transmit the SSID, the RSSI, or the like of the AP therearound. Next, the server 1120 compares the AP information received from the electronic device 1100 with the AP information on the transmitter that is included in the list generated in the step S1170. If there is the transmitter that transmits the AP information matched to the AP information transmitted by the electronic device 1100, the list of the display associated with the transmitter may be transmitted to the electronic device (S1195). Next, the user may select the transmitter and receive the corresponding information.

In addition, when the transmitter and the electronic device are indoors, according to another embodiment, the position of the transmitter and the electronic device may be acquired by using another terminal of which the position is defined in advance. For example, another terminal may infer its own position by a method (e.g. triangulation) for receiving positional information of an indoor map, signal strength, time, or the like and measuring the same. According to another embodiment, any fixed transmitter may transmit its own information and information such as signal strength and time to the server. Next, the server may map the received information to the map having the information on the fixed transmitter and store it. Next, the server may infer the position based on the signal strength received from the transmitter and the electronic device to transmit the positional information. The server may understand the positions of each transmitter and the electronic device and then transmit the map information to which the transmitter and the electronic device of which the positions are determined are mapped to the electronic device of the user.

According to another embodiment, the positions of the transmitter and the electronic device may be acquired using an RF map. The RF map means data obtained by measuring signal strength of a radio wave depending on a geographical feature or a position, noise depending on interference, or the like and mapping them to the map. The RF map is prepared by periodically patrolling and measuring a special vehicle and collecting the measurement for the agreed terminal. The transmitter and the electronic device may infer the position based on the signal strength of the radio wave or the noise that is measured using the RF map. The server may determine the positions of each transmitter and the electronic device and then transmit the map information to which the transmitter and the electronic device of which the positions are determined are mapped to the electronic device of the user.

FIGS. 12A and 12B are diagram illustrating a method for determining and display priority between a plurality of displays by an electronic device according to another embodiment of the present disclosure.

In more detail, FIG. 12A illustrates priority of the display in consideration of a distance of the display with respect to the electronic device as well as a line of sight of the display, when there is at least one display around the electronic device. The display may be positioned in a line of sight (LoS) from the electronic device and may be positioned in a non-line of sight (NLoS) area.

For example, a display A 1210 may be positioned in the line of sight (LoS) of a point of 150 m from the electronic device 1200 and a display B 1215 may be positioned in the line of sight (LoS) of a point of 50 m. Further, a display C 1217 may be positioned in a non-line of sight (NLoS) of a point of 300 m.

In this scenario, for convenience of a user, the electronic device requires a method for determining a display expected to have high selection priority and displaying information on the display. For this purpose, to determine priority for a plurality of displays, at least one of the distance information between the electronic device and the display, the LoS information, or the information on the display that is in a progress direction of the electronic device may be considered.

FIG. 12B is a diagram illustrating that the electronic device displays the information on the display in consideration of the priority of the display, when at least one display is present around the electronic device in the case in which the electronic device includes a display that displays the user interface (UI).

First, when at least one display around the electronic device is sensed, the information on the display may be displayed. In this case, there may be a method 1230 for displaying when a user performs triggering by the method for displaying information on a display and a method 1250 for displaying when an input of a user is present after alert using an upper alert window. The methods 1230 and 1250 illustrated are the same as the method described in the method 600 and 605 of FIG. 6.

The electronic device may sense the triggering of the user or may display the information on at least one display when the input of the user is sensed after alert using the upper alert window (1235). In this case, the electronic device may display the information on the display in consideration of priorities for each display. That is, the order of the displays may be disposed and displayed according to the priority (1235). Next, when the user senses the input to select the information on the displayed display, the electronic device may receive and reproduce the displayed related information as described in FIG. 6.

FIGS. 13A and 13B are diagrams illustrating a method for acquiring, by an electronic device, distance calculation information for determining priority between a plurality of displays used to select the display according to another embodiment of the present disclosure.

In more detail, FIG. 13A is a diagram illustrating a method for directly receiving information from a display in the method for acquiring, by an electronic device, distance calculation information of a display.

A display A 1310 and a display B 1315 may transmit a message, including the distance calculation information when the message is transmitted to an electronic device 1300 (1320). The distance calculation information may include at least one of absolute time information and absolute position information. The display may transmit the distance calculation information when transmitting image information to transmit the information for the distance calculation or the distance calculation information when transmitting data, by a method for transmitting distance calculation information proposed in the present disclosure. Alternatively, only the identification information of the display and the information for the distance calculation may be separately transmitted (1325).

The absolute position information may be acquired by using global positioning system (GPS) information using a satellite or a triangulation using positioning of a base station. The absolute time information may use time of the base station in synchronization or confirm or acquire the absolute time information according to another embodiment. The method for acquiring absolute position information and absolute time information as described above corresponds to the embodiment described in the present disclosure and therefore the absolute position information and the absolute time information may be acquired by another method. The display and the electronic device may confirm the absolute position information and the absolute time information by the method.

According to the embodiment of the present disclosure, if the displays 1310 and 1315 transmit the absolute position of the display to the electronic device 1300, the electronic device may receive the absolute position information of the display and confirm the absolute position of the display. The electronic device may know the distance between the electronic device and the display using the absolute positions of the electronic device and the display.

According to another embodiment of the present disclosure, if the displays 1310 and 1315 transmit the absolute time of the display to the electronic device 1300, the electronic device may receive the absolute time information of the display to know the distance based on the time difference between the screen display device and the electronic device.

By the foregoing example, the electronic device 1300 may confirm that the distance from the display A 1310 is 100 m based on the information transmitted for distance calculation from the display A 1310. When the electronic device 1300 confirms that the distance from the display is 50 m based on the absolute position information transmitted from the display B 1320, the electronic device 1300 may preferentially display the information on the display B or select and display the display B having the higher priority.

FIG. 13B is a diagram illustrating a method for receiving absolute position information on a display from a server in the method for acquiring, by an electronic device, distance calculation information of a display.

In more detail, a display 1335 may transmit the information on the display including the ID of the display and the absolute position of the display to a server 1340. The display 1350 may transmit the absolute position information acquired by the method described in FIG. 13A to the server, along with the ID of the display. The server 1340 may store the ID and the absolute position information of the display that is received from the display. Next, the display 1335 may transmit the ID 1355 of the display to the electronic device 1330. When receiving the ID of the display 1335, the electronic device 1330 may transmit the ID of the display to the server 1340 (1360). The server 1340 may transmit the absolute position information matching the ID of the display device to the electronic device 1330 (1365).

The electronic device 1330 may confirm the distance between the display and the electronic device using the absolute position of the display and the absolute position of the electronic device that are received from the server 1340. Next, the priority of the plurality of displays may be determined based on the confirmed distance information. Determining, by the electronic device 1330, the priority between the plurality of displays and then displaying the information on the display on the screen based on the priority are the same as one described in FIG. 13A.

In addition, the method described with reference to FIG. 13A may be applied to determining the priority between the selected displays when the plurality of displays are selected according to the embodiments described with reference to FIGS. 1 to 5. Further, the embodiments described with reference to FIGS. 6 to 11 may be applied to determining the priority between the respective displays displayed on the screen and displaying the displays together.

FIGS. 14A and 14B are diagrams illustrating a method for acquiring, by an electronic device, line of sight determination information for determining priority between a plurality of displays according to another embodiment of the present disclosure.

In more detail, FIG. 14A is a diagram illustrating the case in which the electronic device directly receives the line of sight determination information from the display.

A display 1410 may transmit LOS determination information to an electronic device 1400 by the method proposed in the present disclosure (1420). The LoS determination information may include the absolute position of the display or the absolute time of the display and may further include transmit power (Tx power) of the display and a Tx antenna gain of the display. The electronic device 1400 may confirm the distance based on the absolute time or the absolute position of the screen by the method described with reference to FIG. 13A.

Further, the electronic device 1400 may use the following method to know whether the display 1410 is in an LoS state. The electronic device 1400 may confirm the distance between the display and the electronic device based on the absolute position or the absolute time of the display, as described with reference to FIG. 13A. Next, the electronic device 1400 may know receive power Pe_rx that needs to be received in the case of the LoS, based on the Tx antenna gain and the receive power of the electronic device. For example, the power Pe_rx that needs to be received in the case of the LoS may be calculated based on the Tx antenna gain of the display, the power of the display, a path loss between the display and the electronic device, and the calculation of the Tx antenna gain of the electronic device. Further, the electronic device 1400 may use the distance information calculated based on the absolute position or the absolute time of the display to obtain the path loss between the display and the electronic device.

When the difference between the receive power Tx power and the expected receive power Pe_rx enters a predetermined range, the electronic device 1400 may determine that the display is in the LoS state. In the case of the display determined to be in the LoS state by the method, the electronic device may be allocated the high priority. The electronic device 1400 may preferentially display the information on the display determined to be in the LoS state or display only the information of the displays that are in the LoS state.

FIG. 14B is a diagram illustrating a method for receiving, by an electronic device, line of sight determination information of a display from a server.

In more detail, a display 1440 may transmit the information on the display, which includes the ID of the display, the absolute position of the display, the Tx power of the transmitter, and the Tx antenna gain of the transmitter, to the server 1450 (1460). The display 1440 may transmit the absolute position information acquired by the method described in FIG. 13A to the server, along with the ID of the display. The server 1340 may store the ID and the absolute position information of the display that is received from the display. Next, the display 1440 may transmit an ID 1470 of a display to the electronic device 1430. When receiving the ID of the display 1440, the electronic device 1430 may transmit the ID of the display to the server 1450 (1480). The server 1450 may transmit the information on the display matching the ID of the display device to the electronic device 1430 (1485). The electronic device 1430 may confirm the Tx power of the transmitter, the Tx antenna gain of the transmitter, and the absolute position of the transmitter that are included in the information on the display matching the ID of the transmitter transmitted in the step S1480.

Next, the electronic device may confirm the LOS state of the display by the method described with reference to FIG. 14A and allocate high priority to the display determined to be in the LoS state by the method. The electronic device 1400 may preferentially display the information on the display determined to be in the LoS state or display only the information of the displays that are in the LoS state.

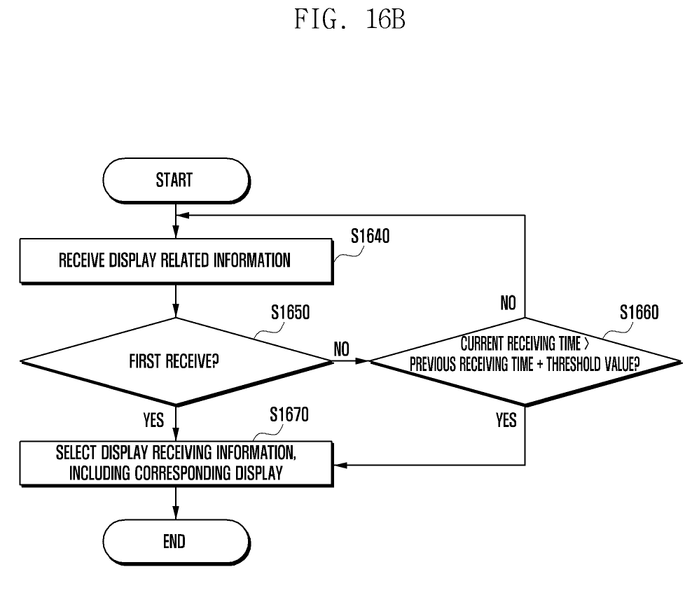

FIG. 15 is a diagram illustrating a method for determining whether a display is present in a progress direction of an electronic device for determining priority between a plurality of displays by the electronic device according to another embodiment of the present disclosure.

An electronic device 1500 may know a distance between the electronic device 1500 and displays 1510 and 1515 by the method of FIG. 13 proposed in the present disclosure. That is, the electronic device 1500 may receive the distance calculation information from the displays 1510 and 1515 to confirm the distance. When acquiring the distance information from the displays 1510 and 1515 by the method proposed in the present disclosure, the electronic device 1500 may store the distance information in the electronic device by the time when the distance information is acquired. A list of the distances between the respective displays 1510 and 1515 and the electronic device 1500 by the time is illustrated in 1530.

According to the embodiment of the present disclosure, the electronic device 1500 may store a distance between the electronic device 1500 and the display A 1510 as Dist_A 1 and store a distance between the electronic device 1500 and the display B 1515 as Dist_B 1, which is acquired at time T1. Further, the electronic device 1500 may store a distance between the electronic device 1500 and the display A 1510 as Dist_A2 and a distance between the electronic device 1500 and the display B 1515 as Dist_B2, which is confirmed at time T2.

It may be confirmed whether the electronic device 1500 is far from the display or is close to the display based on the distance information (for example, Dist_A 1, Dist_A2, or the like) by the time of the display A 1510 stored in the electronic device 1500. For example, by comparing the Dist_A 1 and Dist_A2 that are the information on the display A 1510, when the Dist_A 1 is large, it may be known that the electronic device 1500 is far from the display A and when the Dist_A 1 is small, it may be known that the electronic device 1500 is close to the display A 1510. Further, the same goes for the case of using the information on the display B 1515.

By doing so, it may be confirmed that the electronic device 1500 is near and far the display A 1510 or the display B 1515. Based on this, the priority between the displays may be determined. The electronic device 1500 may display the information on the display based on the priority. For example, the electronic device 1500 may preferentially select and display the information on the display that is close thereto, displays the information on the display that is far therefrom, or display only the information of the display that is close thereto.

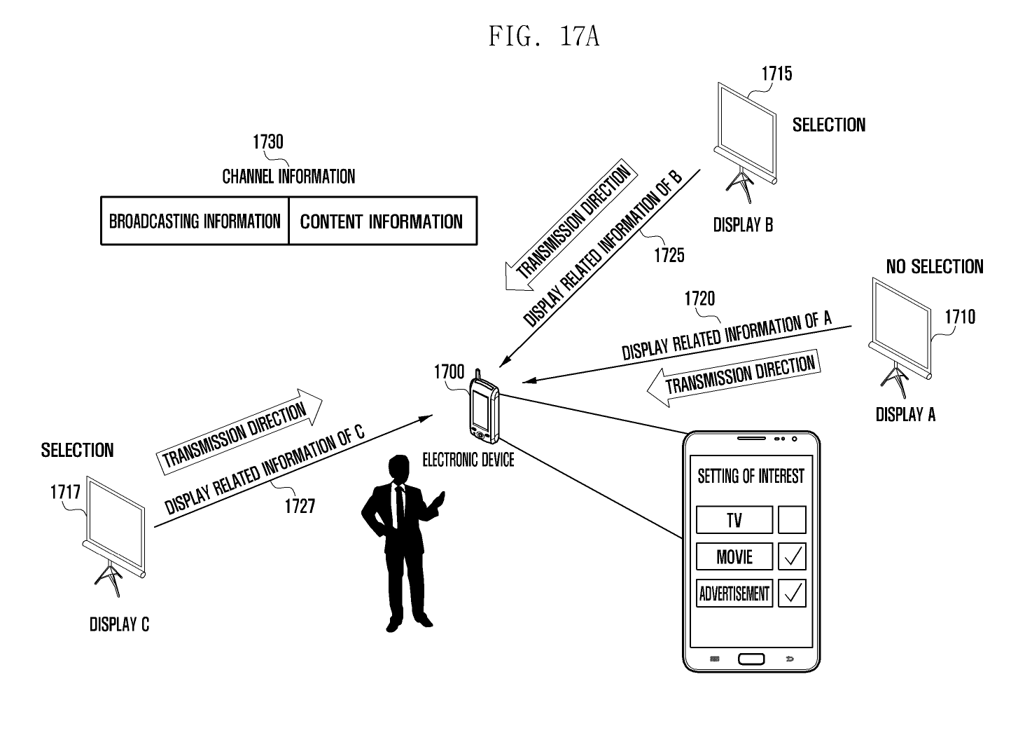

FIGS. 16A and 16B are diagrams illustrating a method for preventing listening again, in selecting a display by an electronic device according to another embodiment of the present disclosure.

FIG. 16A illustrates a method for selecting a display when an electronic device 1600 is re-connected to a display. By the movement of the user, the electronic device 1600 may try to be connected to the display again. In FIG. 16A, for example, it is assumed that the electronic device 1600 selects a display 1615 at time tl to receive image related data. Next, it is assumed that the user moves and thus the electronic device 1600 again receives the display related information (for example, channel information and positional information) transmitted by a display B 1615 at time t2.

In this case, the present disclosure provides a method for selecting a display depending on a difference between a previous receiving time tl and a final receiving time t2. When the difference t2−t1 between the information receiving time of the same display received by the electronic device 1600 exceeds a specific threshold value, the electronic device 1600 determines whether to select the display in consideration of the display again receiving the information and when the difference t2−t1 between the information receiving times of the display received by the electronic device 1600 is smaller than the specific threshold value, the display again receiving the information is excluded. The specific threshold value may also be determined by the user and may be a predetermined fixed value when a service starts. The embodiment of FIG. 16A illustrates that the user directly sets the threshold value. In FIG. 16A, for example, the threshold value is set to be 10 minutes.

Therefore, the difference t2−t1 between the information receiving time of the display B 1615 received by the electronic device 1600 is five minutes and thus is smaller than the specific threshold value (10 minutes), and therefore the electronic device 1600 does not display the information on the display B.

FIG. 16B is a flow chart describing in detail the operation of the electronic device 1600 for the foregoing method. The electronic device may receive the information on the display from the display (S1640). In more detail, the information on the display may include the channel information and the positional information of the display. It may be determined whether the electronic device first receives the information on the display (S1650). When the display does not first receive the information on the display, it may be determined that the current receiving time is larger than a predetermined threshold value added to the previous receiving time (S1660). When the condition is not satisfied, the corresponding display is excluded and may again return to the beginning. When the electronic device satisfies the condition determined in step 51660, the electronic device may add the display to a plural groups of displays to be selected without excluding the display (S1670).

The method of FIG. 16 may be applied to the embodiments described with reference to FIGS. 1 to 5. For example, in FIG. 2, when initially receiving the channel information and the positional information from the display (215, 225, and 235), the electronic device may perform a filtering operation of excluding the display that has connected recording within a predetermined time. Further, the method of FIG. 16 may be applied to the embodiments described with reference to FIGS. 6 to 11. For example, when receiving the absolute position information, the index information, the zone information, or the like from the plurality of displays, the electronic device may perform the filtering operation of excluding the display that has connected recording within a predetermined time. Further, the method of FIG. 16 may be applied to the embodiments described with reference to FIGS. 12 to 15. For example, even though the priority of the plurality of displays is defined, the filtering operation of excluding the display that has connected recording within a predetermined time may be performed based on the time when the information is received from the plurality of displays.

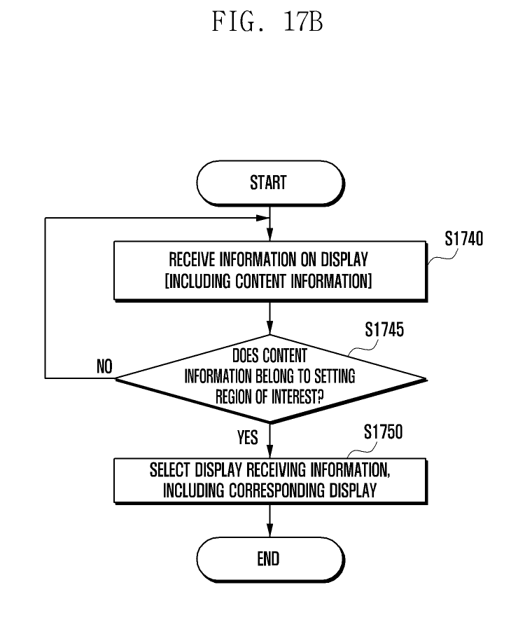

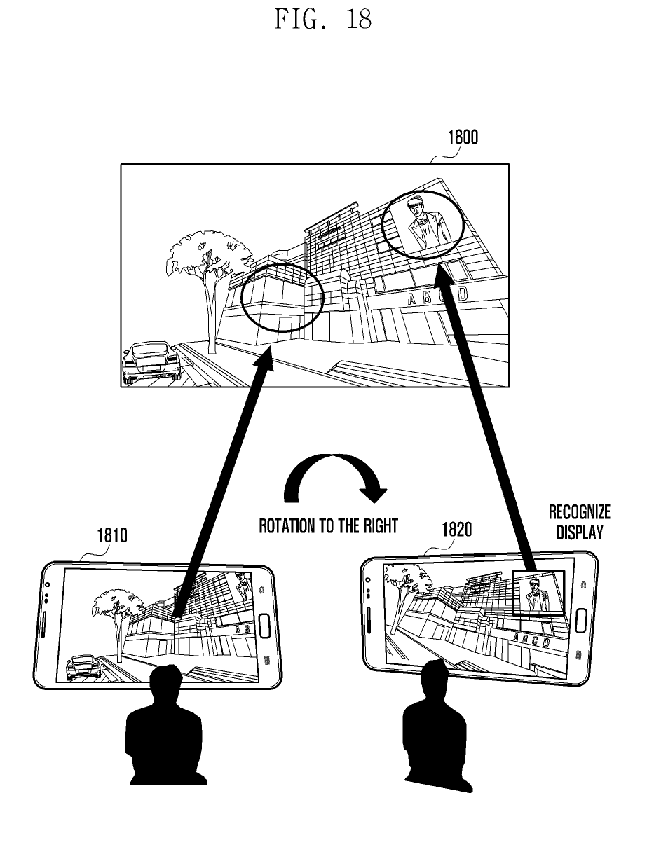

FIGS. 17A and 17B are diagrams illustrating a method for selecting a display in consideration of preference of a user by an electronic device according to another embodiment of the present disclosure.

FIG. 17A is a diagram illustrating that a user configures a content category of interest in an electronic device 1700. It is assumed that in FIG. 17A, the user configures movie and advertisement among TV broadcasting, movie, and advertisement in the electronic device 1700 as an image content. The displays 1710, 1715, and 1710 may transmit the content category reproduced by the display by including the content category in the information on the display. The information on the display may include the channel information and the positional information, in particular, the channel information may include information on the content category. It is assumed that in FIG. 17A, for example, the display A 1710 transmits the content category for TV broadcasting, the display B 1715 transmits the content category for movie, and the display C 1717 transmits the content category for advertisement.

The electronic device 1700 may compare the channel information received from the display therearound with the interest category configured in the electronic device 1700 to select the display. The electronic device 1700 compares the content category information in the received channel information with the image content category configured by the user to display only the matched information on the display on the screen. Therefore, in the embodiment of FIG. 17A, only the information on the display B and the display C is shown.

The content category may use various kinds of categories such as language/presence and absence of subtitle/broadcasting station information as a differentiator. For example, in the case of the language, if a specific language is configured, the electronic device 1700 may display only the information on the display broadcast as a specific language on the screen. Further, only the information on the display having a subtitle may be seen on the screen of the electronic device 1700. As such, in the present disclosure, the display and the electronic device store various content contents previously configured and may use it to filter the displays for each category by reflecting the preference of the user.

A method for aligning and selecting a display in the electronic device 1700 proposed in the present disclosure may be applied as the methods like the embodiments described with reference to FIGS. 1 to 15.

FIG. 17B is a diagram illustrating in more detail the operation of the electronic device described with reference to FIG. 17A.

The electronic device may receive the information on the display (S1740). The information on the display is information required to identify and select the display, in more detail, may include the channel information and the positional information of the display. When receiving the information on the display, the electronic device may receive the information on the display, further including the information on the content category. The electronic device may confirm whether the content category of the display belongs to a setting region of interest that is previously configured by the user (S1745). When the content category of the display belongs to the setting region of interest, the electronic device may select the display receiving the information, including the corresponding display (S1750). When the content category of the display does not belong to the setting region of interest, the electronic device may receive and confirm the display receiving the information, excluding the corresponding display.

FIGS. 18 to 21 describes embodiment included in type 2 of the present disclosure. That is, a type of receiving information by using an image recognition technology of recognizing a screen displayed on a display will be described. The image recognition technology includes a technology of recognizing an image using a camera, an infrared sensor, a visible light recognition apparatus, or the like that are mounted in the electronic device.

FIG. 18 is a diagram illustrating a method for receiving information by recognizing a screen of a display by an electronic device according to another embodiment of the present disclosure.

Referring to FIG. 18, a user may input building, or the like through the image recognition technology by using the electronic device (1800). In this case, when a place where there is no display is input (1810), a continued operation is not performed but when a place where there is a display is input (1815), the display may be recognized. According to the embodiment, the information associated with the recognized display may be directly received from the display or may be received by being connected to the connected server. The acquired information may be automatically reproduced by a user, seen through a PoP-up window, or may be displayed in a screen region of the electronic device by an augmented reality (AR) technology. Hereinafter, a detailed embodiment of a technology of recognizing a screen using the image recognition technology will be described.

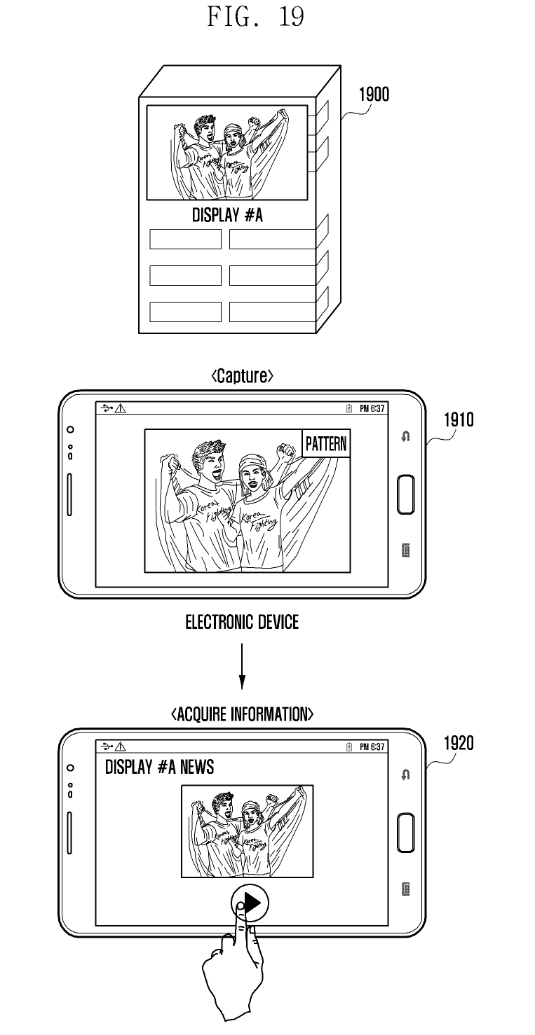

FIG. 19 is a diagram illustrating a method for receiving information by recognizing a predetermined pattern displayed on a screen of a display by an electronic device according to another embodiment of the present disclosure.

Referring to FIG. 19, as one example, a promised pattern may be inserted into a promised portion of a screen region. As one example, a code of the promised pattern may be used. As an example of the code, a QR code, a bar code, or the like may be used. As another example, specific characters, patterns, symbols, marks, and pictures may be used. Further, the position of the pattern may be promised by the method proposed in the present disclosure and the pattern is positioned at a banner of news, a corner, a bezel out of a screen, or the like.

Technically, if an image apparatus of the electronic device acquires a still image, an operation of detecting a pattern from an image is conducted. If a specific region of a transmitting side display is promised in advance by the method proposed in the present disclosure, the still image is divided into (x, y) coordinates to first search for a specific portion. If the search is impossible, another region is searched. On the other hand, when the pattern is recognized, according to the embodiment, the transmission information coming from the transmitter may be classified based on the decrypted information to divide the transmitter. As another embodiment, there is a method for transmitting information recognized from a pattern to a server and allowing the server to transmitting the related information.

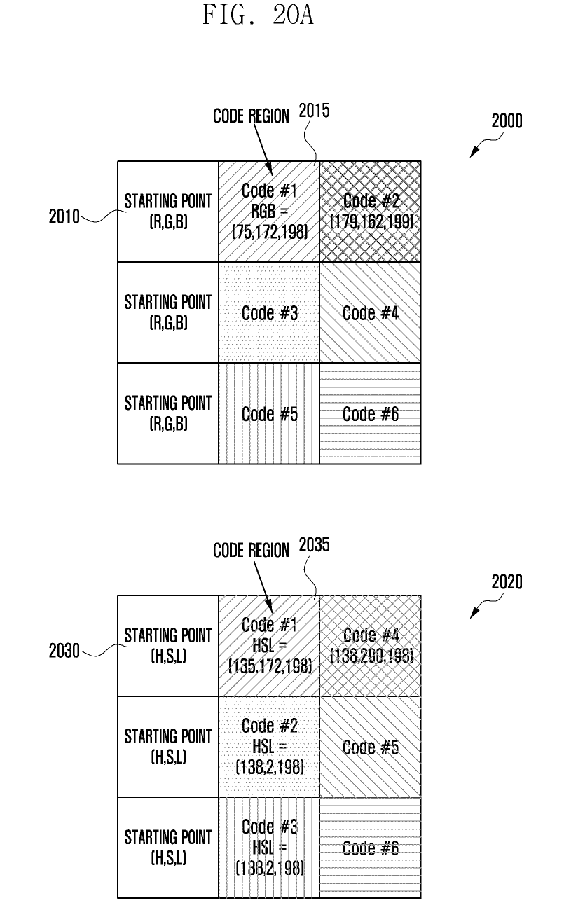

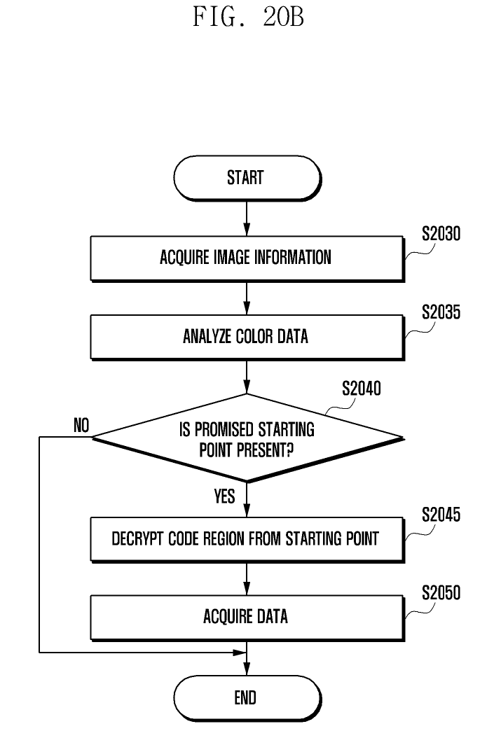

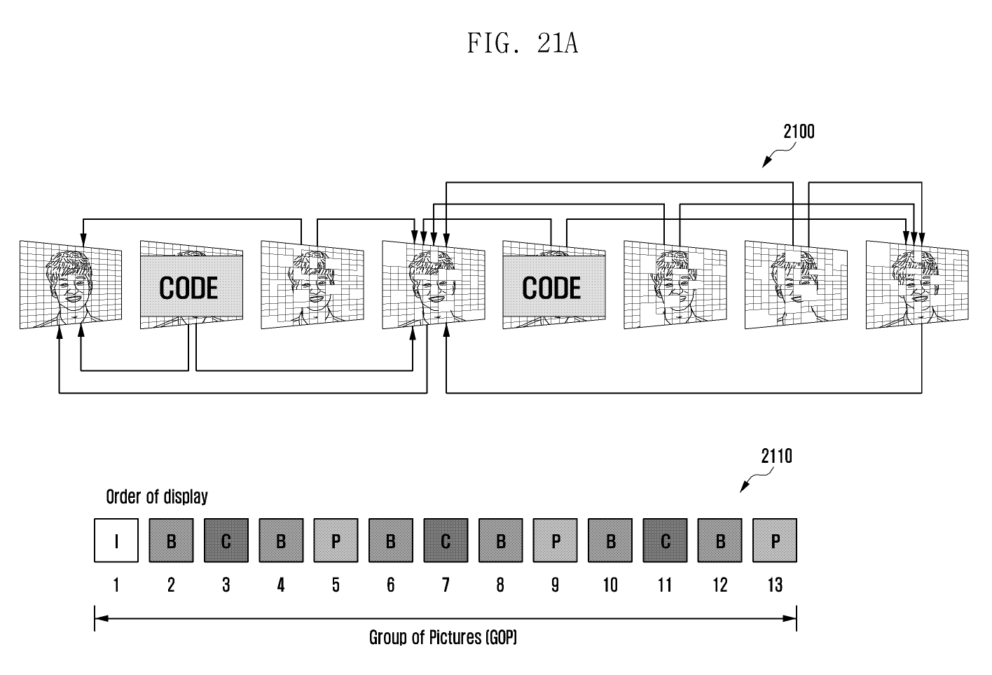

FIG. 20A is a diagram illustrating a method for receiving information by recognizing an inserted code by changing a pixel in a portion of an area of a screen of a display by an electronic device according to another embodiment of the present disclosure.

In more detail, the display may change a pixel of a region of a portion of the screen to insert the promised information. As one example, as illustrated in 2000 of FIG. 20A, according to the method proposed in the present disclosure, adjacent pixels are grouped to be set as one region and then the pixels may be changed to match color values in the region, for example, red, green, and blue (RGB) values. The color value means one information. Repeatedly, if the pixels of the adjacent regions are set to be continuously changed, they may be used as a code the transfers the information. According to the present disclosure, the region is called a code region.

As another example, as illustrated in 2020 of FIG. 20A, according to the method proposed in the present disclosure, adjacent pixels are grouped to be set as one region and then the pixels may be changed to match color values in the region, for example, hue, saturation, and lightness (HSV) values. Next, after the adjacent regions are set as the same color value, the saturation and lightness values of the regions may be changed to represent information. If the electronic device knows a color in an HSL field, the electronic device may decrypt the saturation/lightness information when a color filter is applied based on the change value of the saturation/lightness of the code region.

According to the foregoing embodiment, the color values (for example, RGB, HSL) of the previously promised start region are set to know a start point of the code region. The start region may also be used as a continued region like the code region. An ending point may be represented by the color value like the starting point or the may be determined as the number of previously promised code regions. According to the embodiment, the method of FIG. 20A may be used in one code region.

Describing with reference to a user experience (UX) aspect, as illustrated in FIG. 19, when the user drives the image recognition apparatus of the electronic device to take the display including the changed pixel, the electronic device may recognize the corresponding code region and decrypts the code to acquire the display related information. Next, the electronic device may receive data from a separate server or the display based on the acquired display related information. Next, the received data may be automatically reproduced by the user or seen to the user through the PoP-up window or may be displayed in the screen region of the electronic device by the augmented reality (AR) technology.

FIG. 20B is a flow chart describing an order of the detailed operation of the electronic device for the method of FIG. 20A described above.

The electronic device may use the image recognition apparatus to acquire the image information from the display (S2030). Next, the electronic device may analyze the color data from the acquired image information (S2035). Further, the electronic device may determine whether there is the promised starting point based on the analysis result of the color data (S2040). This may include the case in which the corresponding pixel is continuously present as the predetermined color value. As the analysis result of the color data, when the promised starting point is present, the code region may be decrypted from the starting point (S2045). The electronic device may acquire data from the separate server or the display using the information obtained by the decryption (S2050). In the step 52040, when the promised starting point is present, the electronic device may end the procedure.

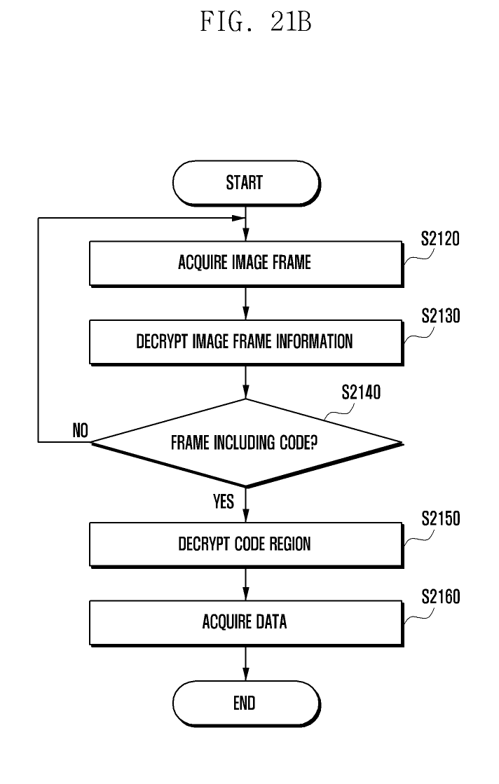

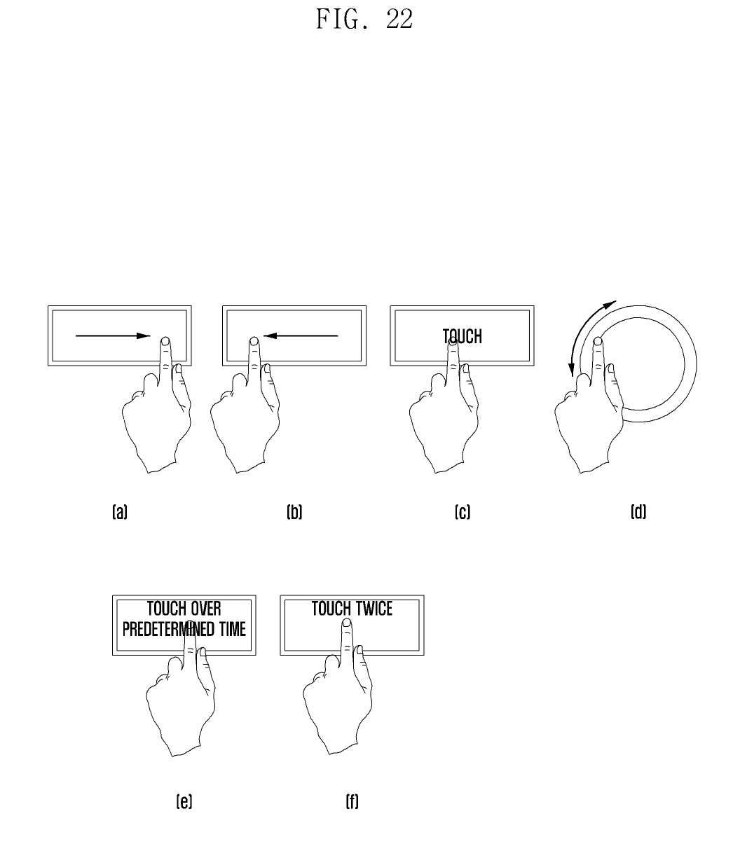

FIG. 21A is a diagram illustrating a method for receiving information by recognizing an inserted code by changing a pixel in a portion of an area of a screen of a display by an electronic device according to another embodiment of the present disclosure.

In more detail, as illustrated in reference numeral 2100, the transmitting side display may insert the code in a continued frame of a portion of the screen to transfer the promised information. When content broadcast through the display is a moving image, the image may represent a motion through the continued frame. In this case, frames of I, P, and B types are present in a moving picture experts group (MPEG)-2 that is one of moving image compression techniques.

I means “interframe” and may be compressed or recovered regardless of other frames like a video frame of DV and has the lowest compression rate among the I, P, and B frames. The P frame means a “predicted” frame and is calculated from the previous frame. That is, only the difference value is coded by calculating only a portion where there is a difference by comparing with the previous frame. B means a frame interpolated with a “bi-directional” frame. This means that the B frame is calculated from the previous frame as well as the next frame may also be used. The B-frame has a difference value between the I or P-frame before the B frame and the I or P-frame after the B-frame. Many data are required to store the I frame, while the P frame is just 1/10 of the I frame and the B frame is the smallest frame. Since the P and B frames are calculated from the I frame, only one I frame and the rest P and B frame may not be included. The scattered I frames need to be present. Otherwise, the accumulated error is too increased and thus the quality of image deteriorates. A set of the continuous images starting at the I-frame is called a group of picture (GOP) 2110.

As one example, a frame sequence is approximately as follows I-B-B-B-P-B-B-B-P-B-B-B-P. The sequence may be changed according to the implementation method or the content configuration. The information on the transmitter and the display proposed in the present disclosure consists of one frame (called a C frame in the present disclosure) and at least one frame in the sequence is instead inserted. For example, if the B frames 3, 7, and 11 are removed, the sequence becomes I-B-C-B-P-B-C-B-P-B-C-B-P. When storing frames of the moving image among the images to decode the C frame, the electronic device may acquire the information on the transmitter and the display.

FIG. 21B is a flow chart describing in detail the operation of the electronic device for the method described with reference to FIG. 21A.

First, the electronic device may use the image sensing apparatus from the moving image displayed on the display to acquire the image frame (S2120). Next, the electronic device may decrypt the acquired image frame information (S2130). Next, it may be determined whether the decrypted image frame is a frame including a code (S2140). In the case of a frame that does not a code, the procedure may again return to the beginning to acquire another image frame. In the step S2140, if it is determined that the image frame is the frame including the code, the electronic device may decrypt the code region (S2150). The electronic device may decrypt the code region to acquire the display related information and use the display related information to receive data from the separate server or the display (S2160).

FIG. 22 is a diagram illustrating a method for controlling data associated with a display based on sensing of an operation of a user by an electronic device according to another embodiment of the present disclosure.

FIG. 22 is a diagram illustrating the operation of the present disclosure proposed for the portion of the electronic device receiving the touch input as the user experience (UX) viewpoint. The electronic device may include a user input module or a sensor module. The user input module may include at least one of a touch panel, a pen sensor, a key, and ultrasonic. Further, the sensor module may include at least one of, for example, a gesture sensor, a gyro sensor, a magnetic sensor, an accelerator sensor, a grip sensor, a proximity sensor, and a red, green, and blue (RGB) sensor. In addition to the mentioned example, according to the embodiment, additional sensors or apparatuses may be included.

If the user wants to receive data, that is, contents proposed in the present disclosure from the display, the operation may be input through the user input module or the sensor module of the electronic device. That is, the electronic device may receive the operation proposed in the present disclosure when the operation of the user is sensed by the user input module or the sensor module as one example. If the electronic device receives the operation of the user, as one example, the electronic device may select one of the plurality of displays using the distance information between the electronic device and the displays therearound, or the like. For example, the electronic device receives the display related information to select the display determined to be present at the closest position, thereby first reproducing the data associated with the display.

As another example, the received data may be aligned based on the information sensed by a camera, an infrared sensor, a gyro sensor, a magnetic sensor, or the like that are connected to the electronic device. Therefore, in addition to the distance, the performance may be made by the input of the operation of the user. The operation of the user may include, for example, a sight line, a finger, camera photographing, or the like.

The operation of controlling, by a user, the data received from the display may be previously configured. Hereinafter, the operation of the user will be described as an example. The operation may be variously represented according to the embodiment. Referring to FIGS. 22A and 22B, an operation of sliding a user input unit, for example, a touch pad, or the like with a user's finger will be described. When a sliding operation in a right direction as illustrated in FIG. 22A is received from a user, data subsequent to the data of the display that is currently being reproduced may be set to be reproduced. On the other hand, in the case of a sliding operation in a left direction, the previous data may be set to be reproduced.

Next, an operation of touching an input unit at a short time will be described with reference to FIG. 22C. If the input unit is touched at a short time, subsequent may be set to be reproduced. Next, when the input unit is a dial form as another example, a touch or rotating operation of drawing a circle will be described with reference to FIG. 22D. In this case, the clockwise rotation may be set to reproduce subsequent data and the counterclockwise rotation may be set to reproduce the previous data. In the search method, the changing speed may be controlled depending on the slide and dial rotation speed. Further, when being changed, a category or a name of the data, a name or a position of the display, or the like are output as a speech signal to be informed to a user. If necessary, if there is no more image to be changed, the procedure returns to the beginning or the state may be informed to the user as an alarm sound.

Next, an operation of touching an input unit by various methods will be described with reference to FIGS. 22E and 22F. For example, as illustrated in FIG. 22E, when the operation of maintaining the input unit for a predetermined time and touching the input unit is sensed, an operation of storing data that is currently being reproduced may be performed. As another example, as illustrated in FIG. 22F, when the operation of touching the controller twice is sensed, an operation of storing data that is currently being reproduced may be performed. The operation described with reference to FIG. 22 may be variously represented according to the embodiment.

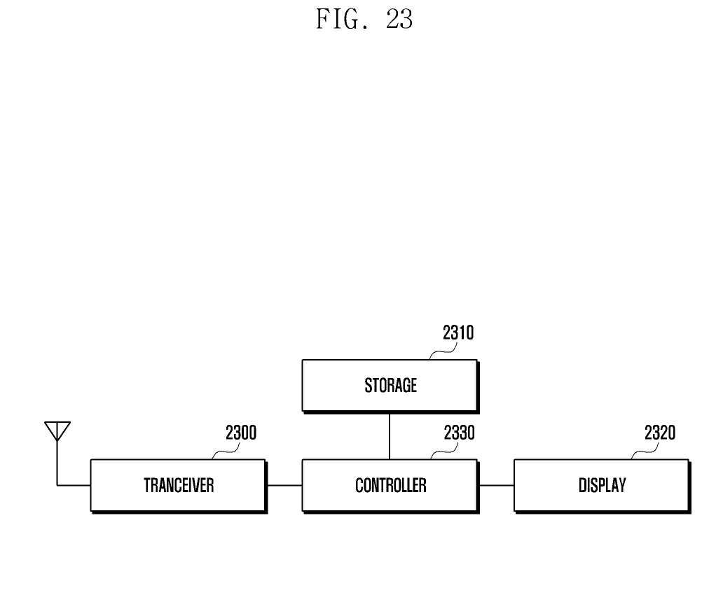

FIG. 23 is a block diagram illustrating an internal structure of a display according to various embodiments of the present disclosure.

In more detail, the display may include a transceiver 2300, a storage 2310, a display 230, and a controller 2330.

The transceiver 2300 may transmit and receive required information according to the present disclosure. The transceiver 2300 may transmit or receive information at least one electronic device. Further, the transceiver 2300 may transmit the received information to the controller 2330. The transceiver 2300 may transmit the display related information to the electronic device. According to various embodiments of the present disclosure, the display related information may include channel information displayed on a display, positional information of the display, identification (ID) of the display, index information on the display, distance calculation information, LOS determination information, or the like. Further, the transceiver 2300 may transmit or receive the display related information to and from the server.

Further, the transceiver 2300 may receive the electronic device related information from the electronic device. The electronic device related information may include information associated with one directivity based on a portion of the electronic device. Further, the electronic device related information may include identifier information on the electronic device.

The storage 2310 may store information required for the operation of the display according to the present disclosure. The storage 2310 may receive and store the information received from the transceiver 2300 from the controller 2330.

The display 2320 may store information required for the operation of the display according to the present disclosure. The display 2320 may display the image or the screen associated with the data received from the server. Alternatively, the display 2330 may display the display related information confirmed by the controller 2330 on a portion of the screen using the code information. The display 2320 can display the predetermined pattern using the color value code of the screen pixel as the starting point of the code region. The display 2320 may display the image including the plurality of image frames and display the code information in some of the plurality of image frames.

The controller 2330 can receive a command from, for example, the foregoing other components (for example, transceiver 2300, storage 2310, display 2320) to decrypt the received command and perform the calculation or the data processing according to the decrypted command.

The controller 2330 can perform a control to confirm the display related information, display the confirmed display related information in a portion of the screen using the code information, and transmit data to the electronic device in response to the reception of the data request message based on the code information from the electronic device.

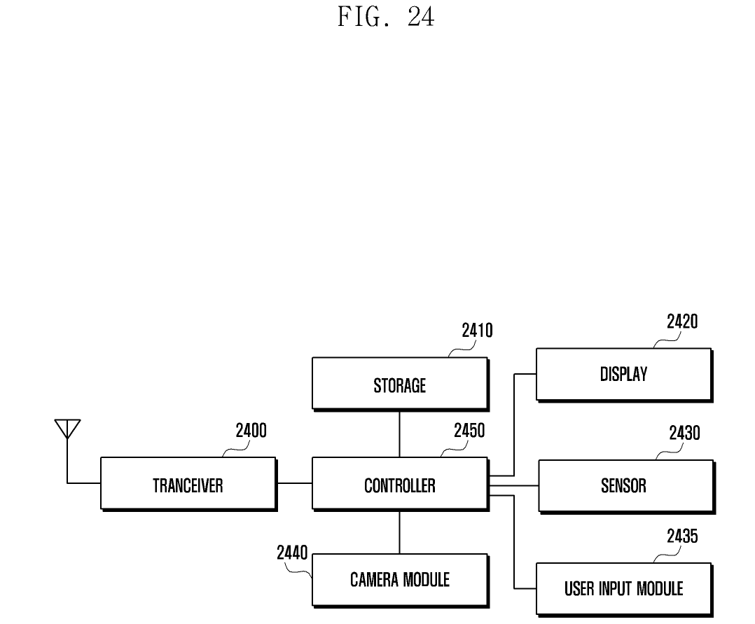

FIG. 24 is a block diagram illustrating an internal structure of an electronic device according to various embodiments of the present disclosure.

In more detail, the electronic device can include a transceiver 2400, a storage 2410, a display 2420, a sensor unit 2430, a user input module 2435, a camera module 2440, and a controller 2430. However, according to various embodiments of the present disclosure, the configuration of the display 2420 can be selectively included.

The transceiver 2400 can connect communication between other electronic devices. The transceiver 2400 can support predetermined short-range communication protocols (for example, wireless fidelity (WiFi), Bluetooth (BT), near field communication (NFC)) or predetermined network communications (for example, Internet, local area network (LAN), wire area network (WAN), telecommunication networks, a cellular network, a satellite network, or plain old telephone service (POTS), or the like. Other electronic devices can be the same (for example: the same type of) device as the electronic device of the present disclosure or other (for example: other types of) devices.

The transceiver 2400 can transmit and receive required information according to the present disclosure to and from the display. The transceiver 2400 can transmit or receive information at least one electronic device. Further, the transceiver 2400 can transmit the received information to the controller 2450.

The transceiver 2400 can receive the display related information from the display. According to various embodiments of the present disclosure, the display related information can include channel information displayed on a display, positional information of the display, identification (ID) of the display, index information on the display, distance calculation information, LOS determination information, or the like. Further, the transceiver 2300 can transmit or receive the display related information to and from the server.

The transceiver 2400 can transmit the electronic device related information to the display. The electronic device related information can include information associated with one directivity based on a portion of the electronic device. Further, the electronic device related information can include identifier information on the electronic device.

Further, the transceiver 2400 can transmit the received display related information to the server and can receive the positional information or the data information on the display from the server in response thereto. Further, the transceiver 2400 can receive map information mapped to the positional information of the display from the server.

The storage 2410 can store information required for the operation of the display according to the present disclosure. The storage 2410 can store commands or data that are received from the controller 2450 or other components (for example: storage 2410, display 2420, sensor unit 2430, camera module 2440, or the like) or generated by the controller 2450 or other components. The storage 2410 can include programming modules such as a kernel, middleware, an application programming interface (API), and an application. Each of the programming modules as described above can be configured of software, firmware, hardware, or a combination of at least two thereof.

The display 2420 can display a picture, an image, data, or the like to the user. The display 2420 can include a panel or hologram. The panel can be, for example, a liquid-crystal display (LCD), active-matrix organic light-emitting diode (AM-OLED), or the like. The panel 262 can be implemented to be, for example, flexible, transparent, or wearable. The panel can also be configured as one module, together with the touch panel. The hologram can use an interference of light to display a three-dimensional image in the air. According to one embodiment, the display 2420 can further include a control circuit for controlling the panel or the hologram.

According to various embodiments of the present disclosure, the display 2420 can display the information on the display corresponding to the display related information received by the electronic device. The display 2420 can display the positional information of the display. The display 2420 can display a map mapped to the positional information of the display on the map information based on the position of the electronic device. Further, when displaying the information on the plurality of displays, the display 2420 can display the information in consideration of the priority between the displays.

The sensor unit 2430 can include at least one of, for example, a gesture sensor, a gyro sensor, a magnetic sensor, an accelerator sensor, a grip sensor, a proximity sensor, and a red, green, and blue (RGB) sensor. The sensor unit 2430 can further include a control circuit for controlling at least one sensor included therein. In addition to the mentioned example, according to the embodiment, additional sensors or apparatuses can be included.

The user input module 2435 can receive, for example, commands or data from the user and transmit the received commands or data to the controller 2450 or to the storage 2410 through the controller 2450. The user input module 2435 can include at least one of a touch panel, a pen sensor, a key, and ultrasonic. The touch panel can recognize the touch input by at least one of a capacitive type, a resistive type, and an infrared type. Further, the touch panel can further include a controller (not illustrated). In the capacitive type, a direct touch as well as proximity recognition can be made. The touch panel can further include a tactile layer. In this case, the touch panel can provide a tactile reaction to a user. The (digital) pen sensor can be implemented using, for example, the same method as or a similar method to receiving the touch input of the user or a separate sheet for recognition. As the key, for example, a keypad or a touch key can be used.

The camera module 2440 is an apparatus that can photograph an image and a moving image and according to one embodiment, can include at least one image sensor (for example: front lens or rear lens), an image signal processor (ISP) (not illustrated), or a flash LED (not illustrated).

The controller 2450 can receive a command from, for example, the foregoing other components (for example, transceiver 2400, storage 2410, display 2420, sensor unit 2430, user input module 2435, camera module 2440) to decrypt the received command and perform the calculation or the data processing according to the decrypted command.

The controller 2450 can perform a control to receive the display related information from at least one display, select at least one of the displays, and receive data based on the at least one display related information selected. The controller 2450 can perform a control to transmit the electronic device related information to the display and select the display transmitting an acknowledge message responding to the electronic device related information.

The controller 2450 can perform a control to display the positional information included in the display related information on the screen and select the display based on the predetermined input received from the user. The controller 2450 can perform a control to display the positional information of the display mapped to the map information based on the position of the electronic device. The controller 2450 can perform a control to display the positional information included in the display related information on the screen in consideration of the priority of the display.

Further, the controller 2450 can perform a control to sense the screen displayed on the display, confirm whether the region including the code information is present in the screen, decrypt the code region when there is the region including the code information, and receive data based on the decrypted code region. Further, the controller 2450 can perform a control to confirm whether there is a predetermined pattern using the color value code of the screen pixel. Further, the controller 2450 can perform a control to confirm whether the frame including the code among the plurality of image frames is present.

According to the embodiments of the present disclosure, it is possible to improve the preference and convenience of the user by providing the method for selecting some of the plurality of displays in consideration of the position, the direction, the operation, or the like of the user using the electronic device and providing the data associated with the selected display.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A method for transmitting and receiving information by an electronic device, comprising:
receiving display related information from at least one display;
receiving a command for selecting at least one of the at least one display; and
receiving data from the selected at least one display based on the at least one display related information.

2. The method of claim 1, further comprising:
transmitting electronic device related information to a display; and
selecting the display transmitting an acknowledge message responding to the electronic device related information.

3. The method of claim 2, wherein the electronic device related information includes a directivity based on a portion of the electronic device.

4. The method of claim 2, wherein the electronic device related information includes an identifier of the electronic device, wherein the electronic device related information is transmitted in a predetermined direction based on a portion of the electronic device.

5. The method of claim 1, further comprising:
displaying positional information included in the display related information on map information based on a position of the electronic device according to a priority of the display, wherein the display is selected based on a predetermined input received from a user, and the priority is based on at least one of a line of sight of the display and a distance change.

6. The method of claim 1, further comprising:
detecting an image of a screen displayed on a display;
determining whether a region including code information exists on the screen;
decrypting the code information in the region; and
receiving data based on the decrypted code information when the region including the code information exists.

7. The method of claim 6, wherein the screen displayed on the display includes a plurality of image frames,
wherein when the region including the code information exists, it is determined whether a frame including the code among the plurality of image frames is present,
wherein that the region including the code information exists is determined by whether a predetermined pattern using a color value code of a screen pixel exists.

8. The method of claim 1, further comprising:
confirming the display related information;
displaying the confirmed display related information on a portion of a screen using code information; and
transmitting data to an electronic device in response to receiving a data request message based on the code information from an electronic device.

9. The method of claim 8, wherein the screen displayed on the display includes a plurality of image frames,
the code information is displayed in some of the plurality of image frames, and
a predetermined pattern using a color value code of a screen pixel is displayed as a starting point of a code region.

10. An electronic apparatus for transmitting and receiving information, comprising:
a transceiver configured to transmit and receive data; and
a controller configured to:
cause the transceiver to receive display related information from at least one display; select at least one of the at least one display; and
receive data from the selected at least one display based on the at least one display related information.

11. The electronic apparatus of claim 10, wherein the controller is configured to cause the transceiver to transmit electronic device related information to the display and to select a display transmitting an acknowledge message responding to the electronic device related information.

12. The electronic apparatus of claim 11, wherein the electronic device related information includes a directivity based on a portion of the electronic device.

13. The electronic apparatus of claim 11, wherein the electronic device related information includes an identifier of the electronic device, and
the electronic device related information is transmitted in a predetermined direction based on a portion of the electronic device.

14. The electronic apparatus of claim 10, further comprising:
a display,
wherein the controller is configured to cause the display to display positional information included in the display related information on a screen, and to select the display based on a predetermined input received from a user.

15. The electronic apparatus of claim 14, wherein the controller is configured to cause the display to display the positional information of the display mapped to map information based on a position of the electronic device.

16. The electronic apparatus of claim 14, wherein the controller is configured to cause the display to display the positional information included in the display related information on a screen in consideration of priority of the display, and
the priority is based on at least one of a line of sight of the display and a distance change.

17. The electronic apparatus of claim 10, wherein the controller further configured to:
cause the transceiver to detect an image of a screen displayed on a display;
determine whether a region including code information exists on a screen;
decrypt the code information in the region; and
receive data based on the decrypted code information.

18. The electronic apparatus of claim 17, wherein the controller is configured to cause the transceiver to determine whether a predetermine pattern using a color value code of a screen pixel exists.

19. The electronic apparatus of claim 17, wherein the screen displayed on the display includes a plurality of image frames, and
the controller is configured to determine whether a frame including a code among the plurality of image frames exists.

20. The electronic apparatus of claim 10, further comprising:
a display; and
wherein the controller further configured to:
confirm a display related information;
display the confirmed display related information in a portion of a screen using code information, and
transmit data to an electronic device in response to receiving a data request message based on the code information from an electronic device,
wherein the controller is further configured to:
cause the display to display a predetermined pattern using a color value code of a screen pixel as a starting point of a code region, and
cause the display to display code information in some of a plurality of image frames when the screen displays on the display includes the plurality of image frames.
